(19) United States
(12) Patent Application Publication
(10) Pub. No.: US 2024/0284284 A1
(43) Pub. Date: Aug. 22, 2024

(54) METHOD AND DEVICE FOR PERFORMING HANDOVER IN WIRELESS COMMUNICATION SYSTEM

(71) Applicant: SAMSUNG ELECTRONICS CO., LTD., Suwon-si (KR)

(72) Inventors: Seungri JIN, Suwon-si (KR); June HWANG, Suwon-si (KR); Beomsik BAE, Suwon-si (KR)

(21) Appl. No.: 18/442,023

(22) Filed: Feb. 14, 2024

(30) Foreign Application Priority Data
Feb. 16, 2023 (KR) 10-2023-0020902

(51) Int. Cl. H04W 36/08; H04W 36/00

(52) U.S. Cl. CPC H04W 36/08; H04W 36/00837

(57) ABSTRACT

The disclosure relates to a 5G or 6G communication system for supporting a higher data transmission rate. A method for processing a control signal in a wireless communication system of the disclosure may include: receiving a first control signal transmitted from a base station; processing the received first control signal; generating a second signal, based on the processing; and transmitting the generated second control signal to the base station.

### CROSS-REFERENCE TO RELATED APPLICATION

This application is based on and claims priority under 35 U.S.C. § 119 to Korea Patent Application No. 10-2023-0020902 filed on Feb. 16, 2023, in the Korea Intellectual Property Office, the disclosure of which is incorporated by reference herein in its entirety.

### BACKGROUND

### 1. Field

The present disclosure relates to a wireless communication system or a mobile communication system. Specifically, the disclosure relates to a method and a device for performing handover in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Based on the discussion described above, the disclosure is to provide a device and a method capable of effectively providing services in a wireless communication system.

More specifically, the present disclosure provides a method and a device, in which, when a terminal is receiving a service via a specific beam from a current serving cell, a beam belonging to another cell may be measured and reported, and if a beam of a neighboring cell becomes better, a cell change to the neighboring cell may be indicated via layer 1/layer 2(L1/L2) signaling and performed.

The disclosure relates to a method for processing a control signal in a wireless communication system, the method includes: receiving a first control signal transmitted from a base station; processing the received first control signal; generating a second signal, based on the processing; and transmitting the generated second control signal to the base station.

Via the method and device for efficiently managing L1/L2 triggered mobility (LTM) and existing layer 3-based handover operations, which are provided in the present disclosure, two different handover requests are not transferred to a terminal, so that the terminal can perform a more reliable handover operation.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to various embodiments of the present disclosure;

FIG. 2 illustrates a radio protocol structure of a wireless communication system according to various embodiments of the present disclosure;

FIG. 3 illustrates a network including a radio protocol of a wireless communication system according to various embodiments of the present disclosure;

FIG. 4 illustrates a scenario in which a terminal connected to a serving cell transmits and receives data via a beam of a TRP of a target cell according to various embodiments of the present disclosure;

FIG. 5 illustrates a scenario in which a terminal transmits and receives data by changing a serving cell and a beam to a TRP of a cell supporting an L1/L2-based beam change according to various embodiments of the present disclosure;

FIG. 6 illustrates overall operations in which L1/L2-based handover is successfully performed according to various embodiments of the present disclosure;

FIG. 7 illustrates overall operations in which L1/L2-based handover is performed and fails according to various embodiments of the present disclosure;

FIG. 8 illustrates overall operations in which L1/L2-based handover is triggered in a serving cell (DU) and corresponding triggering information is transferred from the serving cell (DU) to base station CU according to various embodiments of the present disclosure;

FIG. 9 illustrates overall operations in which existing layer 3 handover is triggered in base station CU and corresponding triggering information is transferred from base station CU to a serving cell (DU) according to various embodiments of the present disclosure;

FIG. 10 illustrates overall operations in which base station CU and a serving cell (DU) transfer handover triggering information according to various embodiments of the present disclosure;

FIG. 11 illustrates operations of performing L1/L2-based beam change and terminal handover according to various embodiments of the present disclosure;

FIG. 12 illustrates a base station operation according to various embodiments of the present disclosure;

FIG. 13 illustrates a structure of a terminal according to various embodiments of the present disclosure; and

FIG. 14 illustrates a structure of a base station according to various embodiments of the present disclosure.

### DETAILED DESCRIPTION

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names defined in the 3rd generation partnership project long term evolution (3GPP LTE) standards will be used for the sake of descriptive convenience. However, the disclosure is not limited by these terms and names, and may be applied in the same way to systems that conform other standards.

Because existing layer 3-based handover may operate concurrently, two types of handover signals may be indicated concurrently. This may occur because entities which determine L1/L2 triggered mobility (LTM) and existing handover operations are different, and ultimately, base station handover indications for a terminal do not match, so that a problem may arise as to which operation the terminal should perform. Hereinafter, the disclosure describes a method and a device for efficiently managing L1/L2-based handover and layer 3-based handover in a wireless communication system to solve the problem above.

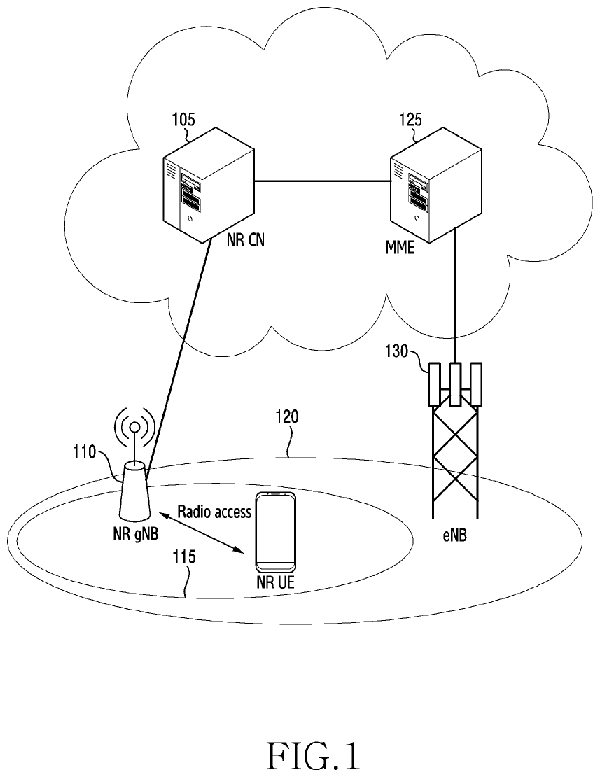

FIG. 1 illustrates a structure of a wireless communication system according to various embodiments of the present disclosure.

Referring to FIG. 1, a radio access network of a wireless communication system may include a next-generation base station (new radio node B, hereinafter NR NB) 110, and a new radio core network (NR CN) or next-generation core network (NG CN) 105. A user terminal (new radio user equipment, hereinafter NR UE or NR terminal) 115 may access an external network via the NR NB 110 and the NR CN 105.

In FIG. 1, the NR NB 110 corresponds to an evolved node B (eNB) of a conventional LTE system. Alternatively, the NR NB 110 may include gNode B (gNB) of an NR system. The NR NB 110 may be connected to the NR UE 115 through a radio channel and may provide outstanding services as compared to a conventional node B. In the wireless communication system or mobile communication system, since all user traffic is serviced through a shared channel, a device that collects state information, such as buffer statuses, available transmit power states, and channel states of UEs, and performs scheduling accordingly, and the NR NB 110 may serve as the device. In general, one NR NB 110 may control multiple cells. In order to implement ultrahigh-speed data transfer beyond the existing LTE, the wireless communication system or mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the wireless communication system or mobile communication system may employ an adaptive modulation & coding (hereinafter referred to as AMC) scheme for determining a modulation scheme and a channel coding rate according to a channel state of a UE. The NR CN 105 may perform functions such as mobility support, bearer configuration, and QoS configuration. The NR CN 105 is a device responsible for various control functions as well as a mobility management function for a UE, and may be connected to multiple base stations. In addition, the wireless communication system or mobile communication system may interwork with the existing LTE system, and the NR CN 105 may be connected to an MME 125 via a network interface. The MME 125 may be connected to an eNB 130 that is an existing base station.

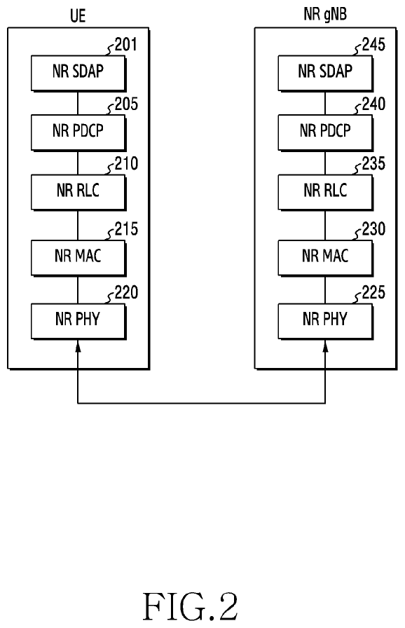

FIG. 2 illustrates a radio protocol structure of a wireless communication system according to various embodiments of the present disclosure.

Referring to FIG. 2, a radio protocol of a wireless communication system may include an NR SDAP layer 201 or 245, an NR PDCP layer 205 or 240, an NR RLC layer 210 or 235, and an NR MAC layer 215 or 230 in each of a UE and an NR base station.

The main functions of the NR SDAP layer 201 or 245 may include, but not limited thereto, some of functions below:
Transfer of user data (transfer of user plane data);
Mapping between a QoS flow and a data bearer for uplink and downlink (mapping between a QoS flow and a DRB for both DL and UL);
Marking a QoS flow ID in uplink and downlink (marking QoS flow ID in both DL and UL packets); and/or
Mapping a reflective QoS flow to a data bearer with respect to UL SDAP PDUs (reflective QoS flow to DRB mapping for the UL SDAP PDUs).

According to an embodiment, whether to use a header of the SDAP layer device, or whether to use a function of the SDAP layer device may be configured for the UE through an RRC message for each PDCP layer device, each bearer, or each logical channel. Furthermore, in a case where an SDAP header is configured, an NAS QoS reflective configuration one-bit indicator (NAS reflective QoS) and an As QoS reflective configuration one-bit indicator (AS reflective QoS) of the SDAP header may indicate the UE to update or reconfigure mapping information relating to a QoS flow and a data bearer for uplink and downlink. The SDAP header may include QoS flow ID information indicating a QoS. The QoS information may be used as data processing priority, scheduling information, etc. for smoothly supporting the service.

The main functions of the NR PDCP layer 205 or 240 may include, but not limited thereto, some of functions below:
Header compression and decompression (ROHC only);
Transfer of user data;
In-sequence delivery (In-sequence delivery of upper layer PDUs);
Out-of-sequence delivery (Out-of-sequence delivery of upper layer PDUs);
Reordering (PDCP PDU reordering for reception);
Duplicate detection (Duplicate detection of lower layer SDUs);
Retransmission (Retransmission of PDCP SDUs);
Ciphering and deciphering; and/or
Timer-based SDU discard (Timer-based SDU discard in uplink).

The reordering of the NR PDCP device refers to a function of reordering PDCP PDU received from a lower layer in an order based on PDCP sequence numbers (SNs). The reordering of the NR PDCP device may include a function of transferring data to a higher layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC layer 210 or 235 may include, but not limited thereto, some of functions below:
Data transfer (Transfer of upper layer PDUs);
In-sequence delivery (In-sequence delivery of upper layer PDUs);
Out-of-sequence delivery (Out-of-sequence delivery of upper layer PDUs);
ARQ (Error correction through ARQ);
Concatenation, segmentation and reassembly (Concatenation, segmentation and reassembly of RLC SDUs);
Re-segmentation (Re-segmentation of RLC data PDUs);
Reordering (Reordering of RLC data PDUs);
Duplicate detection;
Error detection (Protocol error detection);
RLC SDU discard; and/or
RLC re-establishment.

The in-sequence delivery of the NR RLC device may indicate a function of transferring RLC SDUs received from a lower layer to a higher layer in sequence. Furthermore, the in-sequence delivery may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to a higher layer, may include a function of, although there is a lost RLC SDU, if a predetermined timer has expired, sequentially transferring, to a higher layer, all the RLC SDUs received before the timer is started, or may include a function of, although there is a lost RLC SDU, if a predetermined timer has expired, sequentially transferring all the RLC SDUs received up to the current, to a higher layer. In addition, the NR RLC device may process RLC PDUs in a reception order (an order in which the RLC PDUs have arrived, regardless of an order based on sequence numbers) and then transfer the processed RLC PDUs to a PDCP device regardless of order (out-of-sequence delivery). In a case of segments, the NR RLC device may receive segments stored in a buffer or to be received in the future, reconfigure the segments to be one whole RLC PDU, then process the RLC PDU, and transfer the processed RLC PDU to a PDCP device. The NR RLC layer may not include a concatenation function, and the concatenation function may be performed in an NR MAC layer or replaced with a multiplexing function of an NR MAC layer.

The out-of-sequence delivery function of the NR RLC device may indicate a function of immediately transferring RLC SDUs received from a lower layer regardless of the order thereof. Furthermore, the out-of-sequence delivery function may include a function of, if one original RLC SDU is divided into several RLC SDUs and then the RLC SDUs are received, reassembling the several RLC SDUs and transferring the reassembled RLC SDUs, and may include a function of storing an RLC sequence number (SN) or a PDCP sequence number (SN) of received RLC PDUs and arranging order to record lost RLC PDUs.

The NR MAC layer 215 or 230 may be connected to several NR RLC layer devices configured in a single UE, and the main functions of the NR MAC layer 215 or 230 may include some of functions below:
Mapping (Mapping between logical channels and transport channels);
Multiplexing and demultiplexing (Multiplexing/demultiplexing of MAC SDUS);
Scheduling information reporting;
HARQ (Error correction through HARQ);
Priority handling between logical channels (Priority handling between logical channels of one UE);
Priority handling between UEs (Priority handling between UEs by means of dynamic scheduling);
MBMS service identification;
Transport format selection; and/or
Padding.

An NR PHY layer 220 or 225 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer.

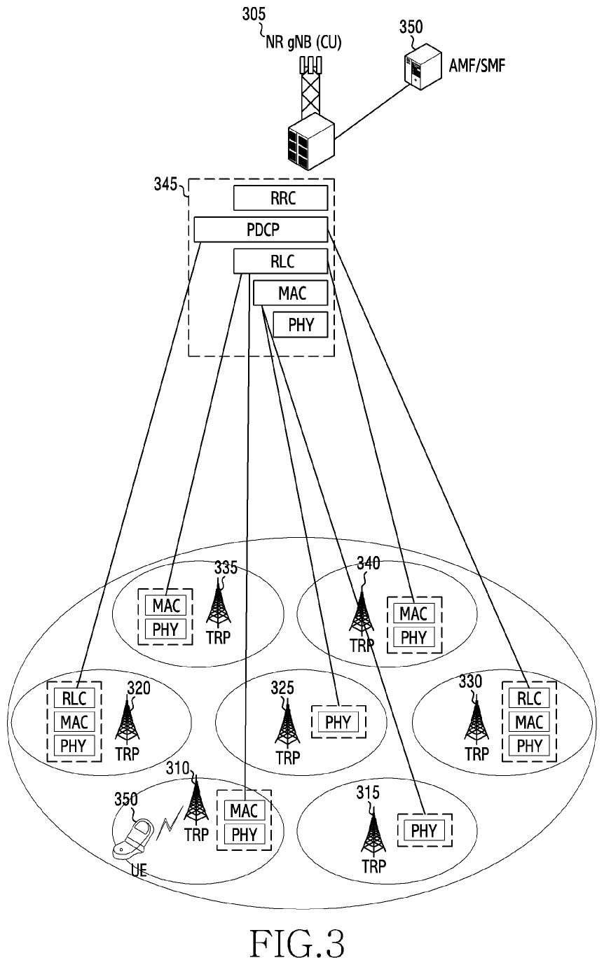

FIG. 3 illustrates a network including a radio protocol of a wireless communication system according to various embodiments of the present disclosure.

Referring to FIG. 3, a cell served by an NR gNB 305 operating on a beam basis may include multiple transmission reception points (TRPs) 310, 315, 320, 325, 330, 335, and 340. The TRPs 310, 315, 320, 325, 330, 335, and 340 represent blocks in which some functions of transmitting and receiving a physical signal are separated from the legacy NR base station (eNB), and may include multiple antennas. The NR gNB 305 may also be expressed as a central unit (CU), and a TRP may also be expressed as a distributed unit (DU). Functions of the NR gNB 305 and the TRPs may be separately configured in each layer of PDCP/RLC/MAC/PHY layers 345. That is, the TRPs 315 and 325 may have only the PHY layer and perform a function of the corresponding layer, the TRPs 310, 335, and 340 may have only the PHY layer and the MAC layer and perform functions of the corresponding layers, and the TRPs 320 and 330 may have only the PHY layer, the MAC layer, and the RLC layer and perform functions of the corresponding layers. In particular, the TRPs 310, 315, 320, 325, 330, 335, and 340 may use a beamforming technology of generating narrow beams in multiple directions by using multiple transmission/reception antennas so as to transmit and receive data. A user terminal 350 may access the NR gNB 305 and an external network via the TRPs 310, 315, 320, 325, 330, 335, and 340. In order to provide services to users, the NR gNB 305 may collect state information of terminals, such as a buffer state, an available transmission power state, and a channel state, and support connections between the terminals and a core network (CN), in particular, an AMF/SMF (e.g., user terminal 350), by scheduling the collected state information.

The TRPs in the disclosure may include structures 315 and 325 in which the TRPs may have only the PHY layer and perform the function of the corresponding layer.

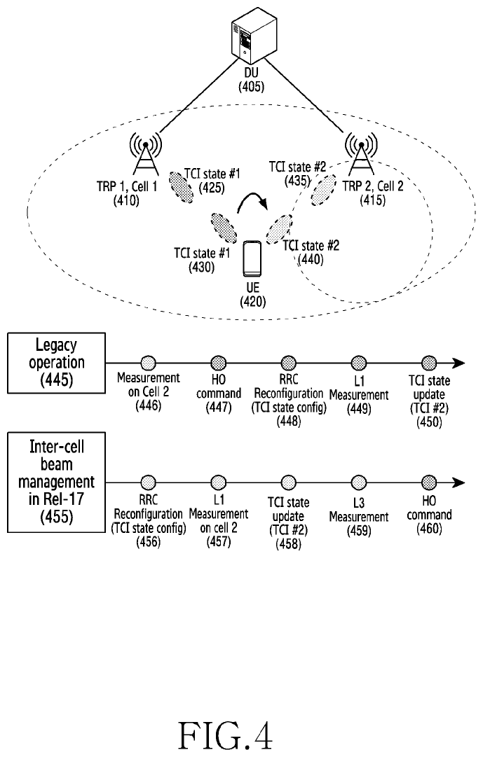

FIG. 4 illustrates a scenario in which a terminal connected to a serving cell transmits and receives data via a beam of a transmission reception point (TRP) of a target cell according to various embodiments of the present disclosure. Specifically, FIG. 4 shows diagrams which illustrate a scenario for inter-cell beam management and illustrate a scenario in which a terminal transmits and receives data via a beam of a TRP of a neighboring cell supporting beam change based on L1/L2, while maintaining a connection to a serving cell, according to an embodiment. According to various embodiments of the disclosure, a cell to which a terminal is currently being connected may be referred to as a serving cell, and a cell for handover may be referred to as a target cell or an object cell. According to an embodiment, a neighboring cell or another cell, which is a non-serving cell, may include a target cell or object cell to which a terminal performs handover.

FIG. 4 illustrates a case where multiple cells (TRP1-Cell 1 and TRP2-Cell 2) 410 and 415 exist within a single distributed unit (DU) 405, but the overall content of the disclosure is also applicable to a case of an inter-DU (e.g., respective DUs constitute one TRP-Cell). In addition, in the disclosure, a cell (TRP 2, cell 2) which is not a serving cell and supports L1/L2-based mobility (beam change and serving cell change) may be referred to as a neighboring cell, a non-serving cell, an additional cell with physical cell identity (PCI) different from the serving cell, or the like.

Referring to FIG. 4, an existing terminal beam change procedure 445 may include enabling a terminal 420 to transmit and receive data in a connected state via TRP 1 410 of serving cell 1, wherein TCI state 1 425 or 430 which is an optimal beam is used. The terminal may receive, from the serving cell 410 via RRC configuration information, an indication of configuration information for L3 channel measurement (radio resource management (RRM)) on an additional cell (TRP 2-Cell 2) 415 having PCI different from that of the serving cell, and may perform an L3 measurement operation 446 for a corresponding frequency and cell. Then, the serving cell (TRP 1-Cell 1) 410 may indicate handover to the corresponding cell (TRP 2-Cell 2) 415 in operation 447, based on a reported measurement value, and after the handover is completed, additional RRC configuration information may be transferred to the terminal 420 via TRP 2-Cell 2 415 in operation 448. The RRC configuration information may include L1 measurement-related configurations (CSI-RS measurement and reporting) and UL/DL configuration information in the corresponding cell, etc., and in particular, TCI state configuration information for a PDCCH and a PDSCH may be included. The terminal may perform L1 measurement in operation 449 according to the configuration, and the base station may update a TCI state in operation 450 via L1/L2 signaling according to measurement reporting. During this procedure, TCI state 2 440 that is an optimal beam may be indicated. In the above-described operation, cell 1 may be the serving cell before the handover, and cell 2 may be the serving cell after the handover. That is, until the optimal beam is indicated, a number of procedures and additional time may be required even after the handover.

According to an embodiment of the disclosure, unlike the existing terminal beam change procedure 445, an improved beam change technique 455 considered in the disclosure may include the following content. The terminal may receive a beam configuration associated with the additional cell (TRP 2-Cell 2) 415 having PCI different from that of the serving cell 410 via RRC configuration information (e.g., operation 456) from the serving cell 410. For the beam configuration associated with the additional cell (TRP 2-Cell 2) 415 having PCI different from that of the serving cell, that is, a part associating a TCI state corresponding to TRP2, a method of associating and indicating a new cell ID (physical cell ID, PCI; additionalPCI-r17) is applied as shown in TABLE 1.

TABLE 1

```
TCI-State
TCI-State ::=  SEQUENCE {
  tci-StateId  TCI-StateId,
  qcl-Type1  QCL-Info,
  qcl-Type2  QCL-Info  OPTIONAL, -- Need R
  ...,
  [[
  additionalPCI-r17  AdditionalPCIIndex-r17  OPTIONAL, --
Need R
  pathlossReferenceRS-Id-r17  PUSCH-PathlossReferenceRS-Id
OPTIONAL, -- Cond JointTCI
  ul-powerControl-r17  Uplink-powerControlId-r17  OPTIONAL --
Cond JointTCI
]]
}
```

In addition, a unified TCI state framework may be applied for beam management between corresponding cells.

According to an embodiment of the disclosure, the unified TCI state framework may be a framework in which a common TCI state framework is applied in an uplink, a downlink, a common channel, and a dedicated channel, and one of a joint UL/DL mode and a separate UL/DL mode may be configured as shown in TABLE 2.

TABLE 2

```
MIMO Parameters
MIMOParam-r17 ::= SEQUENCE {
  additionalPCI-ToAddModList-r17 SEQUENCE (SIZE(1..maxNrofAdditionalPCI-r17))
OF SSB-MTC-AdditionalPCI-r17 OPTIONAL, -- Need N
  additionalPCI-ToReleaseList-r17 SEQUENCE (SIZE(1..maxNrofAdditionalPCI-r17)) OF
AdditionalPCIIndex-r17 OPTIONAL, -- Need N
  unifiedTCI-StateType-r17  ENUMERATED {separate, joint}
OPTIONAL, -- Need R
  uplink-PowerControlToAddModList-r17 SEQUENCE (SIZE (1..maxUL-TCI-r17)) OF
Uplink-powerControl-r17  OPTIONAL, -- Need N
  uplink-PowerControlToReleaseList-r17 SEQUENCE (SIZE (1..maxUL-TCI-r17)) OF
Uplink-powerControlId-r17  OPTIONAL, -- Need N
  sfnSchemePDCCH-r17  ENUMERATED {sfnSchemeA,sfnSchemeB}
OPTIONAL, -- Need R
  sfnSchemePDSCH-r17  ENUMERATED {sfnSchemeA,sfnSchemeB}
OPTIONAL -- Need R
}
```

1. Joint UL/DL mode: UL and DL are configured to share the same TCI configuration (in PDSCH-Config) as shown in TABLE 3.

TABLE 3

```
Joint TCI state list
dl-OrJoint-TCIStateList-r17  CHOICE {
    explicitlist  SEQUENCE {
      dl-orJoint-TCI-State-ToAddModList-r17  SEQUENCE (SIZE (1..maxNrofTCI-
States)) OF TCI-State
                                                  OPTIONAL, -- Need N
      dl-orJoint-TCI-State-ToReleaseList-r17  SEQUENCE (SIZE (1..maxNrofTCI-
States)) OF TCI-StateId
                                                OPTIONAL -- Need N
  },
  unifiedTCI-StateRef-r17  ServingCellAndBWP-Id-r17
}
```

2. Separate UL/DL mode: Separate TCI configurations are provided for UL and DL. A TCI state for DL conforms to a configuration in dl-OrJoint-TCIStateList-r17 (in PDSCH-Config), and a TCI state for UL conforms to ul-TCI-StateList-r17 (in BWP-UplinkDedicated) as shown in TABLE 4.

TABLE 4

```
TCI state list
ul-TCI-StateList-r17  CHOICE {
    explicitlist  SEQUENCE {
      ul-TCI-ToAddModList-r17 SEQUENCE (SIZE (1..maxUL-TCI-r17)) OF TCI-UL-
State-r17 OPTIONAL, -- Need N
      ul-TCI-ToReleaseList-r17 SEQUENCE (SIZE (1..maxUL-TCI-r17)) OF TCI-UL-
State-Id-r17 OPTIONAL -- Need N
    },
    unifiedTCI-StateRef-r17 ServingCellAndBWP-Id-r17
  } OPTIONAL, -- Need R
```

After the configuration on TRP 2-Cell 2 is provided while the terminal is being RRC connected to serving cell 1, the terminal may perform L1 measurement on TRP 2-Cell 2 according to the received configuration on TRP 2-Cell 2 and report a performance result to the serving cell (cell 1) 410, in operation 457. When a change to a specific beam (TCI state 2) 435 or 440 of TRP 2 (cell 2) 415 is determined to be required rather than the serving cell beam (TCI state 1) 425 or 430 according to the measurement result, the serving cell may trigger a beam change and indicate the beam change to the terminal via L1/L2 signaling, in operation 458. The terminal may perform beam change to the specific beam (TCI state 2) 440 of TRP 2 (cell 2) 415 according to the beam change indication of the serving cell, and may perform physical channel configuration and higher-layer configuration operations associated with the configured beam. Afterwards, the terminal may remain connected to the serving cell (cell 1) 410, but may transmit and receive data by using a channel link of TRP 2 (cell 2) 415 (PDCCH/PDSCH reception and PUCCH/PUSCH transmission). That is, transmission and reception on a common control channel may be performed via the serving cell (cell 1) 410. Then, the terminal may perform an L3 measurement operation 459 according to a measurement configuration configured in the independent serving cell, and may receive a handover command message from the serving base station (cell 1) and change the serving cell to cell 2, in operation 460. Via the technique 455, the terminal may perform, while being connected to the serving cell, data transmission and reception to and from specific TRP 2 of cell 2 supporting L1/L2-based mobility, and may continuously use the corresponding beam even after the handover.

According to an embodiment of the disclosure, the RRC configuration for the configuration and operation related to L1 measurement and reporting in operation 457 includes the following content. The content may also be basically applied to other embodiments of the disclosure, and an improvement technique may be added in future embodiments.

### 1. CSI Measurement Configuration

Measurement required CSI-RS resources and resource pools (nzp-CSI-RS, csi-IM, and csi-SSB); and/or
Measurement required CSI-RS resource configuration (aperiodic, semi-persistent) and triggering configuration.

When a CSI-RS resource is based on an SSB resource, additional PCI information is provided to enable L1 measurement from neighboring cells (up to 7 neighboring cells (PCI) can be added in one serving cell) as shown in TABLE 5 and TABLE 6.

TABLE 5

```
CSI SSB resources
CSI-SSB-ResourceSet ::=  SEQUENCE {
  csi-SSB-ResourceSetId  CSI-SSB-ResourceSetId,
  csi-SSB-ResourceList  SEQUENCE (SIZE(1..maxNrofCSI-SSB-ResourcePerSet))
OF SSB-Index,
  ...,
  [[
  servingAdditionalPCIList-r17 SEQUENCE (SIZE(1..maxNrofCSI-SSB-
ResourcePerSet)) OF ServingAdditionalPCIIndex-r17 OPTIONAL -- Need R
  ]]
}
ServingAdditionalPCIIndex-r17 ::= INTEGER(0..maxNrofAdditionalPCI-r17)
```

TABLE 6

```
SSB MTC
SSB-MTC-AdditionalPCI-r17 ::=  SEQUENCE {
  additionalPCIIndex-r17  AdditionalPCIIndex-r17,
  additionalPCI-r17  PhysCellId,
  periodicity-r17  ENUMERATED { ms5, ms10, ms20, ms40, ms80, ms160,
spare2, spare1 },
  ssb-PositionsInBurst-r17  CHOICE {
    shortBitmap  BIT STRING (SIZE (4)),
    mediumBitmap  BIT STRING (SIZE (8)),
    longBitmap  BIT STRING (SIZE (64))
  },
  ss-PBCH-BlockPower-r17 INTEGER (-60..50)
}
```

### 2. CSI Report Configuration

Report type: Periodic report, semi-periodic report via PUCCH, semi-periodic report via PUSCH, and aperiodic report via PUSCH (periodic, semi-persistent for PUCCH, semi-persistent for PUSCH, and aperiodic);
Report quantity; and/or
Other configurations required for reporting.

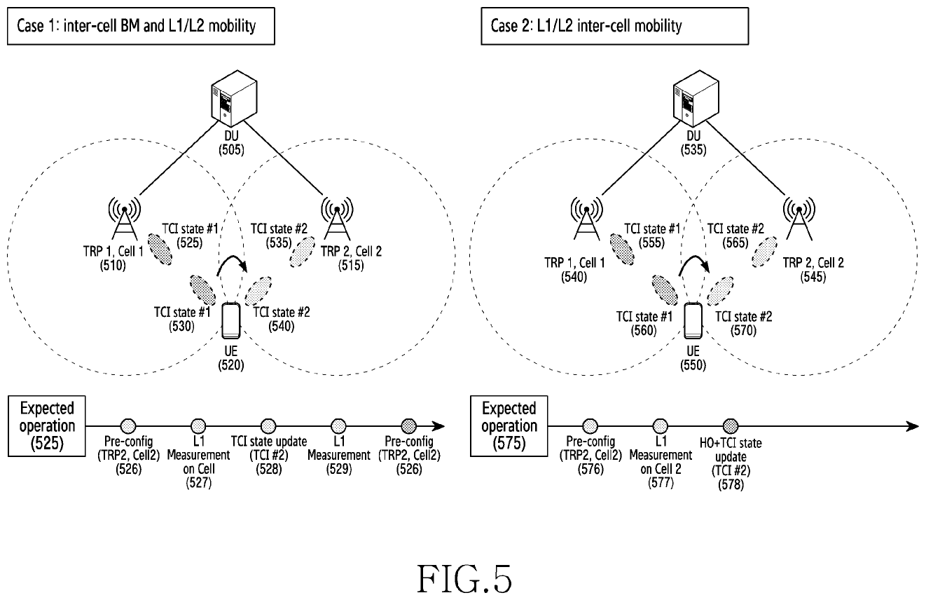

FIG. 5 illustrates a scenario in which a terminal transmits and receives data by changing a serving cell and a beam to a TRP of a cell supporting an L1/L2-based beam change according to various embodiments of the present disclosure.

FIG. 5 illustrates a case where multiple cells (TRP1-Cell 1 and TRP2-Cell 2) 510, 515, 540, and 545 exist within a single distributed unit (DU) 505 or 535, but the overall content of the disclosure is also applicable to a case of an inter-DU (e.g., respective DUs constitute one TRP-Cell).

Referring to FIG. 5, unlike the existing terminal beam change procedures (e.g., 445 and 455 in FIG. 4), improved beam change techniques 525 and 575 being considered in the embodiments are as follows.
1. Embodiment 1 525: After performing inter-cell beam management (change), L1/L2 handover is performed.
2. Embodiment 2 575: L1/L2 handover is performed immediately.

First, to describe overall operations of embodiment 1, a terminal 520 may receive, from a serving cell 510 via RRC configuration information, common configuration and dedicated configuration information for the additional cell (TRP 2-Cell 2) 515 having PCI different from that of the serving cell, in operation 526. That is, the terminal 520 may receive, in advance from the serving cell 510, configuration information corresponding to ServingCellConfig and ServingCellConfigCommon, and ServingCellID or candidateCellID (cell ID associated with PCI). The configuration information may be provided in a pre-configuration form in the RRC configuration, and may include configuration information for multiple cells. In addition, the configuration includes all configuration information (cell configuration, bearer configuration, measurement-related configuration, security key configuration, etc.) applied when the terminal moves (performs handover) to the additional cell having PCI different from that of the serving cell. In addition, the configuration may include configurations related to L1 measurement and reporting and the unified TCI state configuration described in operation 456 of FIG. 4.

Various embodiments of the disclosure provide detailed descriptions for a structure of providing, in advance, configurations on candidate neighboring cells to which L1/L2 handover may be performed, in particular, a method of configuring an L3 measurement-related configuration (MeasConfig), a radio bearer configuration (RadioBearerConfig), and a cell group configuration (CellGroupConfig) including a cell configuration. In particular, the disclosure provides a method capable of, when transferring the configuration information to the terminal, efficiently transferring the configuration information compared to when only specific configuration information of specific LTM candidate cells is updated. In addition, the disclosure also provides a method of, when an RLC bearer configuration, a logical channel configuration, a MAC configuration, etc. are generally applicable even within the cell group configuration, effectively configuring the same to reduce signaling overhead. Additionally, in various embodiments of the disclosure, not only an intra-CU scenario but also an inter-CU scenario is considered.

After the configuration on TRP 2-Cell 2 515 is provided while being RRC connected to serving cell 1 510, the terminal may perform L1 measurement on TRP 527-Cell 2 515 in operation 527 according to the received configuration on TRP 2-Cell 2 and report a performance result to the serving cell (cell 1) 510. When a change to a specific beam (TCI state 2) 540 of TRP 2 (cell 2) 515 is determined to be required rather than a serving cell beam (TCI state 1) 525 according to the measurement result, the serving cell 510 may trigger a beam change and indicate the beam change to the terminal via L1/L2 signaling, in operation 528. The terminal 520 may perform beam change to TRP 2 (cell 2) 515 via the beam change indication received from the serving cell 510 and transmit and receive data via TRP 2 (cell 2) 515. In this case, the serving cell is not changed, and the terminal is still RRC connected to the serving cell (cell 1) 510. Then, the terminal 520 still performs L1 measurement on TRP 2-Cell 2 515 and reports a corresponding result to the serving cell (cell 1) 510. When L1 measurement reported by the terminal 520 satisfies a triggering condition (detailed operations will be described in detail below) for handover to TRP 2-Cell 2 515, the serving cell (cell 1) 510 may indicate handover to the terminal. The handover indication to the terminal from the serving cell may be transferred via an L1/L2 message. That is, a MAC CE or DCI may include an indicator indicating the handover.

To describe overall operations of embodiment 2, a terminal 550 may receive, from the serving cell 540 via RRC configuration information, common configuration and dedicated configuration information for the additional cell (TRP 2-Cell 2) 545 having PCI different from that of the serving cell, in operation 576. That is, the terminal 550 may receive, from the serving cell 540, configuration information corresponding to ServingCellConfig and ServingCellConfigCommon, and ServingCellID or candidateCellID (cell ID associated with PCI). The configuration information for the cell may be a cell group level configuration (CellGroupConfig) rather than a cell-level configuration, or may be provided via a configuration according to RRC configuration messages (RRCReconfiguration).

According to an embodiment of the disclosure, the configuration information may be provided in a pre-configuration form in the RRC configuration, and may include configuration information for multiple cells. In addition, the configuration may include all configuration information (cell configuration, bearer configuration, security key configuration, etc.) applied when the terminal moves (performs handover) to the corresponding cell. In addition, the configuration may include configurations related to L1 measurement and reporting and the unified TCI state configuration described in operation 456 of FIG. 4. An embodiment of the disclosure provides description for a structure of providing, in advance, configurations on candidate neighboring cells to which L1/L2 handover may be performed, in particular, a method of applying delta configuration and configuration information for a reference cell to the configurations of the candidate neighboring cells.

According to an embodiment of the disclosure, after the configuration on TRP 2-Cell 2 545 is provided while being RRC connected to serving cell 1 540, the terminal 550 may perform L1 measurement on TRP 2-Cell 2 545 in operation 577 according to the received configuration and report a corresponding result to the serving cell (cell 1) 540. When a beam change to a specific beam (TCI state 2) 570 of TRP 2 (cell 2) 545 while concurrently performing handover is determined to be required rather than a serving cell beam (TCI state 1) 560 according to the measurement result, the serving cell 540 may trigger the beam change and handover and indicate the beam change to the terminal 550 via L1/L2 signaling, in operation 578. The terminal 550 may perform handover while concurrently performing beam change to TRP 2 (cell 2) 545, based on the beam change indication received from the serving cell 540, and transmit and receive data via TRP 2 (cell 2) 545. In this case, the terminal 550 may apply the configuration information for a target cell to which handover is performed, the configuration information having been preconfigured in operation 576. In this case, the terminal may perform random access depending on whether uplink synchronization is necessary, and random access to the target cell may be omitted. Detailed operations will be description with reference to the drawings below.

The existing layer 3 handover technology used in various embodiments of the disclosure may all be applied to various handover technologies (conditional handover (CHO), dual active protocol stack (DAPS) handover, and conditional PSCell addition and change (CPAS)) including basic handover (a base station indicates handover by transferring a handover command RRC message) used from Rel-15. That is, although omitted in the disclosure, in the description of LTM and existing layer 3 handover operations, particularly, an operation to prevent concurrent handover triggering may include all existing handover technologies.

In addition, in various embodiments of the disclosure, with regard to an operation of a terminal when LTM and existing layer 3 handover are concurrently triggered and transferred to the terminal, it is assumed that the terminal operates based on first received handover signaling. Additionally, in a situation where the terminal may concurrently receive multiple handover messages, it may be necessary to define a signal to which priority is to be given. In one way, LTM may be applied first, and in another way, existing layer 3 handover may be processed first.

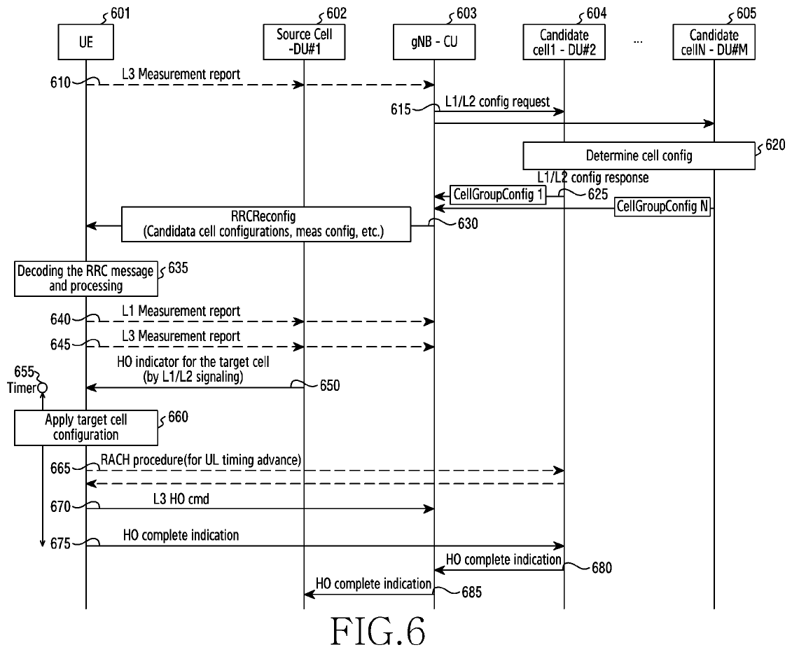

FIG. 6 illustrates overall operations in which L1/L2-based handover is successfully performed, according to various embodiments of the present disclosure. Specifically, FIG. 6 illustrates, as scenario 1 described in the disclosure, overall operations in which L1/L2-based handover is successfully performed.

Referring to FIG. 6, in operation 610, an RRC connected terminal 601 may perform data transmission and reception to and from source cell 1 602 and then transmit, to source cell 1 602, layer 3 measurement values for neighboring cells and a serving cell according to configured layer 3 measurement and reporting. In this case, the terminal 601 may transmit the layer 3 measurement values for the neighboring cells and the serving cell to a CU 603 of a base station according to actually configured layer 3 measurement and reporting. This is because base station CU 603 is responsible for RRC message processing and determines mobility.

In operation 615, base station CU 603 may generate a message (L1/L2 config request message) for requesting configuration information for L1/L2-based handover and transmit the message via an F1 interface to LTM candidate neighboring cells 604 and 605 according to the measurement value report received from the terminal 601. In FIG. 6, the candidate cells are illustrated in association with the DUs, but the candidate cells and DUs may be mapped 1:1, or multiple candidate cells may be included in one DU. In addition, the message for requesting configuration information for L1/L2-based handover may be an existing handover request message, a UE context request message, a UE context modification request message, etc., and may be a new F1 or Xn message. The message for requesting configuration information for L1/L2-based handover may be a message for requesting, from neighboring cells, determination as L1/L2-based handover candidate cells and may be, at the same time, a message for requesting RRC configuration information applied when L1/L2-based handover is performed to a corresponding cell. The RRC configuration information (CellGroupConfig 1, . . . , CellGroupConfig N) applied when L1/L2-based handover is performed may be transferred in one of a cell level structure, a cell group level structure, and an RRC message level structure. The message for requesting configuration information for L1/L2-based handover may be for concurrently transferring a configuration and information on a reference cell, and the message for requesting configuration information for L1/L2-based handover may include an indicator for requesting to transfer the configuration information for L1/L2-based handover to the candidate neighboring cells 604 and 605 by applying delta configuration. The indicator for requesting to transfer the configuration information for handover by applying delta configuration may be requested for each cell or may be commonly requested for all cells.

In operation 620, the candidate neighboring cells 604 and 605 having received the message for requesting configuration information for L1/L2-based handover may generate, based on delta configuration, configuration information of each candidate neighboring cell when L1/L2-based handover is applied based on the transferred configuration information of the reference cell.

In operation 625, each candidate neighboring cell 604 or 605 may include the generated configuration information for L1/L2-based handover in a configuration information response message (L1/L2 config response message) for L1/L2-based handover, and transmit the response message to base station CU 603.

In operation 630, base station CU 603 may generate an RRC message and transmit the same to the source cell 602, and the source cell 602 may transfer the RRC message to the terminal 601. The RRC message may include the configuration information (Pre-Config1, . . . , Pre-ConfigN) for the neighboring candidate cells, to which L1/L2-based handover (LTM) is applied. Pre-Config included in the RRC message may include layer 3 (L3) measurement configurations, bearer configurations for the LTM candidate cells, which are generated by the base station, and CellGroupConfig configurations received from the LTM candidate cells in operation 625.

In operation 635, the terminal 601 having received the RRC message may perform a procedure of decoding and processing the RRC message. The processing procedure of the terminal 601 may include ASN.1 decoding and validity determination for the received message, a method of storing and managing configuration details, and the like.

In operation 640, the terminal 601 may perform layer 1 (L1) measurement and reporting for each candidate neighboring cell and may also, at the same time, perform L3 measurement and reporting in operation 645 according to the configurations. The source cell having received the L1 measurement report may determine handover based on a corresponding measurement value, and indicate L1/L2 handover to the terminal 601 in operation 650. In operation 640, a MAC CE and DCI including a handover indicator may be used for L1/L2 signaling. The L1 measurement value transfer for determining L1/L2 handover and the handover determination in operations 640 and 650 may be performed by the source cell (DU) or source base station CU 603. If base station CU 603 makes all determinations, the source cell 602 may transfer, to base station CU 603, the L1 measurement value received from the terminal 601, and transfer L1/L2 signaling to the terminal according to the handover determination indication of base station CU 603. However, when the source cell makes a final determination, the source cell may, without transferring of the L1 measurement value to the base station, determine handover on its own and transfer L1/L2 signaling to the terminal, according to measurement value criteria (threshold and measurement value range) for handover determination for each candidate neighboring cell, which is received from a previous base station.

In operation 655, when the L1/L2 handover indication is transferred to the terminal, the terminal may start a handover procedure and drive a timer for L1/L2 handover. The timer for L1/L2 handover may be a newly configured timer for LTM, or an existing T304 timer may be reused.

In operation 660, the terminal 601 may apply a configuration on a target cell to which L1/L2 handover is applied. The configuration may be one of the LTM candidate neighboring cell configurations previously received in operation 630.

In operation 665, according to the applied configuration, the terminal may perform random access when random access is required for the target cell, and when random access is neither indicated nor required (when uplink synchronization is already performed or configured), a random access procedure may be omitted. In addition, at the same time when the procedure is performed, base station CU 603 may determine existing layer 3 handover for the terminal according to results of the L3 measurement and reporting in operation 645, and may transfer, to the terminal, a handover indication in operation 670. For LTM, this may be a case where the serving cell (DU) triggers the LTM, and may be a case where there is no information exchange with the serving cell (DU). That is, since base station CU 603 cannot identify whether the serving cell (DU) has indicated LTM to the terminal 601, handover may be indicated to the terminal via an independent L3 measurement and reporting procedure.

In operation 675, the terminal may perform a handover completion procedure with the target cell. The handover completion procedure may be a handover completion procedure for the LTM or a completion procedure for the existing L3 handover. In the scenario of the disclosure, description is provided for a case where LTM is indicated first, and therefore a handover completion procedure for LTM is described. The procedure may vary according to a handover completion indication method, and when a configuration of a target cell is received at an RRC message level, the procedure may be transferring of an RRCReconfigurationComplete message. However, when a cell level or cell group level configuration is received, a new handover completion indication message (new RRC message or MAC CE) may replace the procedure.

In addition, since application for intra-CU is considered in the scenario of the disclosure, the target cell (DU) 604 having received a handover completion message may transfer the received handover completion message to base station CU 603 in operation 680. In this case, the target cell (DU) 604 may transfer the received handover completion message, as it is, to base station CU 603 via the F1 interface, or based on the received information, newly process the message and transfer the same. Thereafter, in operation 685, base station CU 603 may transfer information on handover completion to the source cell 602 and indicate to release terminal context.

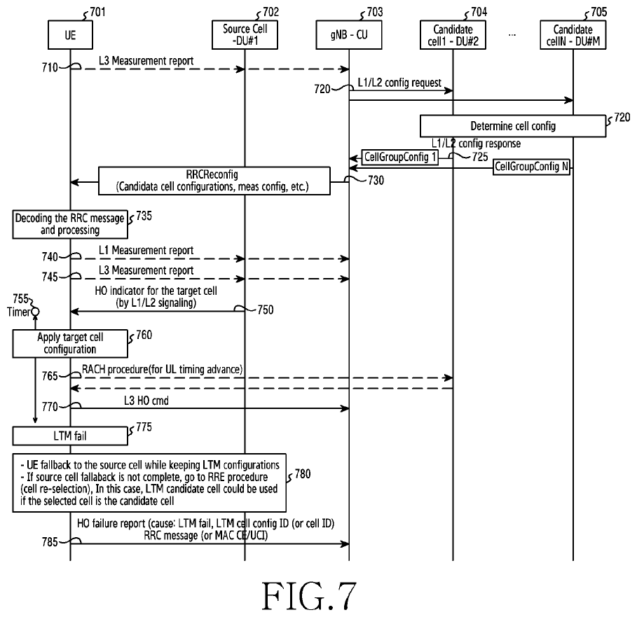

FIG. 7 illustrates overall operations in which L1/L2-based handover is performed and fails, according to various embodiments of the present disclosure. Specifically, FIG. 7 illustrates, as scenario 2 described in the disclosure, overall operations in which L1/L2-based handover is performed and fails.

In operation 710, an RRC connected terminal 701 may perform data transmission and reception to and from source cell 1 702 and then transfer, to source cell 1 702, layer 3 measurement values for neighboring cells and a serving cell according to configured layer 3 measurement and reporting. In this case, the terminal 701 may transmit the layer 3 measurement values for the neighboring cells and the serving cell to a CU 703 of a base station according to actually configured layer 3 measurement and reporting. This is because base station CU 703 is responsible for RRC message processing and determines mobility.

In operation 715, base station CU 703 may generate a message (L1/L2 config request message) for requesting configuration information for L1/L2-based handover and transmit the message via an F1 interface to LTM candidate neighboring cells 704 and 705 according to the measurement value report received from the terminal. In FIG. 7, the candidate cells are illustrated in association with the DUs, but the candidate cells and DUs may be mapped 1:1, or multiple candidate cells may be included in one DU. In addition, the message for requesting configuration information for L1/L2-based handover may be an existing handover request message, a UE context request message, a UE context modification request message, etc., and may be a new F1 or Xn message. The message for requesting configuration information for L1/L2-based handover may be a message for requesting, from neighboring cells, determination as L1/L2-based handover candidate cells and may be, at the same time, a message for requesting RRC configuration information applied when L1/L2-based handover is performed to a corresponding cell. The RRC configuration information (CellGroupConfig 1, . . . , CellGroupConfig N) applied when L1/L2-based handover is performed may be transferred in one of a cell level structure, a cell group level structure, and an RRC message level structure. The message for requesting configuration information for L1/L2-based handover may be for concurrently transferring a configuration and information on a reference cell, and the message for requesting configuration information for L1/L2-based handover may include an indicator for requesting to transfer the configuration information for L1/L2-based handover to the candidate neighboring cells 704 and 705 by applying delta configuration. The indicator for requesting to transfer the configuration information for L1/L2-based handover by applying delta configuration may be requested for each cell or may be commonly requested for all cells.

In operation 720, the candidate neighboring cells 704 and 705 having received the message for requesting configuration information for L1/L2-based handover may generate, based on delta configuration, configuration information of each candidate neighboring cell when L1/L2-based handover is applied based on the transferred configuration information of the reference cell.

In operation 725, each candidate neighboring cell 704 or 705 may include the generated configuration information for L1/L2-based handover in a configuration information response message (L1/L2 config response message) for L1/L2-based handover, and transmit the response message to base station CU 703.

In operation 730, base station CU 603 may generate an RRC message and transmit the same to the source cell 602, and the source cell 602 may transfer the RRC message to the terminal 601. The RRC message may include configuration information (Pre-Config1, . . . , Pre-ConfigN) for neighboring candidate cells to which L1/L2-based handover (LTM) is applied. Pre-Config included in the RRC message may include layer 3 (L3) measurement configurations, bearer configurations for the LTM candidate cells, which are generated by the base station, and CellGroupConfig configurations received from the LTM candidate cells in operation 725.

In operation 735, the terminal 701 having received the RRC message may perform a procedure of decoding and processing the RRC message. The processing procedure of the terminal 701 may include ASN.1 decoding and validity determination for the received message, a method of storing and managing configuration details, and the like.

In operation 740, the terminal 701 may perform layer 1 (L1) measurement and reporting for each candidate neighboring cell and may also, at the same time, perform L3 measurement and reporting in operation 745 according to the configurations. The source cell having received the L1 measurement report may determine handover based on a corresponding measurement value, and indicate L1/L2 handover to the terminal in operation 750. In operation 740, a MAC CE and DCI including a handover indicator may be used for L1/L2 signaling. The L1 measurement value transfer for determining L1/L2 handover and the handover determination in operations 740 and 750 may be performed by the source cell (DU) or source base station CU. If base station CU 703 makes all determinations, the source cell 702 may transfer, to base station CU 703, the L1 measurement value received from the terminal 701, and transfer L1/L2 signaling to the terminal according to the handover determination indication of base station CU. However, when the source cell makes a final determination, the source cell may, without transferring of the L1 measurement value to the base station, determine handover on its own and transfer L1/L2 signaling to the terminal, according to measurement value criteria (threshold and measurement value range) for handover determination for each candidate neighboring cell, which is received from a previous base station.

In operation 755, when the L1/L2 handover indication is transferred to the terminal, the terminal may start a handover procedure and drive a timer for L1/L2 handover. The timer for L1/L2 handover may be a newly configured timer for LTM, or an existing T304 timer may be reused.

In operation 760, the terminal 701 may apply a configuration on a target cell to which L1/L2 handover is applied. The configuration may be one of the LTM candidate neighboring cell configurations previously received in operation 730.

In operation 765, according to the applied configuration, the terminal may perform random access when random access is required for the target cell, and when random access is neither indicated nor required (when uplink synchronization is already performed or configured), a random access procedure may be omitted. In addition, at the same time when the procedure is performed, base station CU 703 may determine existing layer 3 handover for the terminal according to results of the L3 measurement and reporting in operation 745, and may transfer, to the terminal, a handover indication in operation 770. For LTM, this may be a case where the serving cell (DU) triggers the LTM, and may be a case where there is no information exchange with the serving cell (DU). That is, since base station CU 703 cannot identify whether the serving cell (DU) has indicated LTM to the terminal 701, handover may be indicated to the terminal via an independent L3 measurement and reporting procedure.

In operation 775, the terminal may fail in the LTM handover to the target cell. Reasons for the LTM handover failure may include expiration of a timer for the LTM handover or expiration of an existing T304 timer, a failure of random access to the target cell to which LTM handover is performed, etc. As operations performed when the terminal fails in the LTM handover, the following operations may be performed in operation 780. However, the operations are not limited thereto.
When LTM fails, the terminal 701 may perform fallback to the previous source cell 702 and attempt to make a connection. To this end, the terminal 701 may need to maintain configuration information for the source cell even when the LTM is triggered. In addition, even after the fallback to the source cell 702, LTM configuration information for the LTM target cell may be maintained. This is to allow LTM to be re-triggered according to the existing configuration.
If the fallback to the source cell 702 cannot be completely performed, the terminal 701 may enter an RRC re-establishment procedure to reselect connectable cells. If a cell found via cell reselection is one of the LTM candidate cells, the terminal 701 may attempt to make a connection by applying a preconfigured RRC configuration for the cell.

In operation 785, the terminal may generate a handover failure report message and transfer the message to base station CU 703, in the connected cell (source cell or target cell). The handover failure report message may be UEInformationResponse or another uplink RRC message. In addition, the handover failure may be reported via a new MAC CE or uplink control signal (uplink control information (UCI)). Information included in the handover failure report message may include the following information. However, the information is not limited thereto.
Indicator indicating that handover has failed due to the LTM failure.
Information of the target cell to which LTM has been attempted and has failed: LTM cell configuration index or actual cell index (physical cell index (PCI)) information.

In the embodiment of the disclosure, for the scenarios described in FIG. 6 and FIG. 7, particularly, a situation occurs in which LTM and existing handover are concurrently triggered, and it is unclear how a terminal should operate in the corresponding situation, so that clear operations need to be defined. This will be discussed in detail in the following embodiments. In addition, in the following embodiments, in order to express a more general situation, description will be extended to an inter-CU scenario.

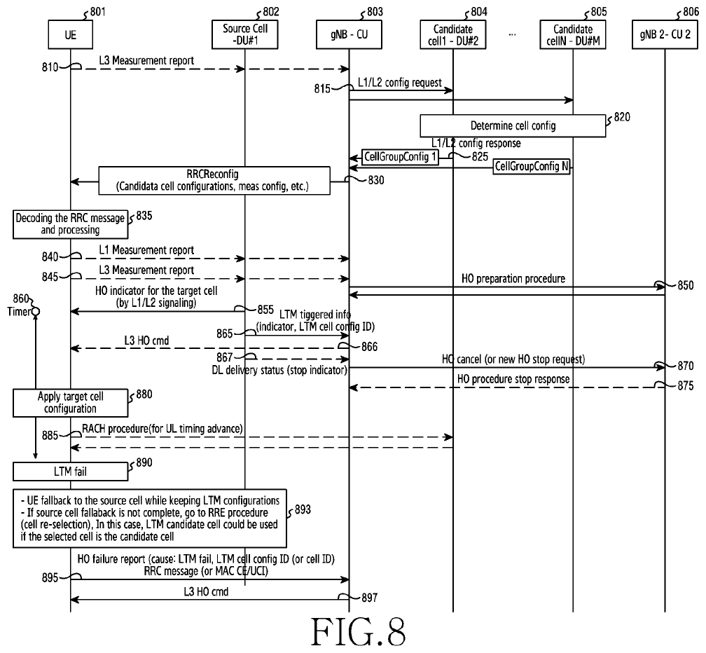

FIG. 8 illustrates overall operations in which L1/L2-based handover is triggered in a serving cell (DU) and corresponding triggering information is transferred from the serving cell (DU) to base station CU, according to various embodiments of the present disclosure. Specifically, FIG. 8 illustrates, as embodiment 1 described in the disclosure, a method in which L1/L2-based handover is triggered in a serving cell (DU) and corresponding triggering information is transferred from the serving cell (DU) to base station CU, and overall operations of the same.

In operation 810, an RRC connected terminal 801 may perform data transmission and reception to and from source cell 1 802 and then transfer, to source cell 1 802, layer 3 measurement values for neighboring cells and a serving cell according to configured layer 3 measurement and reporting. In this case, according to actually configured layer 3 measurement and reporting, the layer 3 measurement values for the neighboring cells and the serving cell may be transferred to base station CUI 803. This is because base station CUI 803 is responsible for RRC message processing and determines mobility.

In operation 815, base station CUI 803 may generate a message (L1/L2 config request message) for requesting configuration information for L1/L2-based handover and transfer the message via an F1 interface to LTM candidate neighboring cells 804 and 805 according to the measurement value report received from the terminal. In FIG. 8, the candidate cells are illustrated in association with the DUs, but the candidate cells and DUs may be mapped 1:1, or multiple candidate cells may be included in one DU. In addition, the message for requesting configuration information for L1/L2-based handover may be an existing handover request message, a UE context request message, a UE context modification request message, etc., and may be a new F1 or Xn message. The message for requesting configuration information for L1/L2-based handover may be a message for requesting, from neighboring cells, determination as L1/L2-based handover candidate cells and may be, at the same time, a message for requesting RRC configuration information applied when L1/L2-based handover is performed to a corresponding cell. The RRC configuration information (CellGroupConfig 1, . . . , CellGroupConfig N) applied when L1/L2-based handover is performed may be transferred in one of a cell level structure, a cell group level structure, and an RRC message level structure. The message for requesting configuration information for L1/L2-based handover may be for concurrently transferring a configuration and information on a reference cell, and the message for requesting configuration information for L1/L2-based handover may include an indicator for requesting to transfer the configuration information for L1/L2-based handover to the candidate neighboring cells 804 and 805 by applying delta configuration. The indicator for requesting to transfer the configuration information for L1/L2-based handover by applying delta configuration may be requested for each cell or may be commonly requested for all cells.

In operation 820, the candidate neighboring cells 804 and 805 having received the message for requesting configuration information for L1/L2-based handover may generate, based on delta configuration, configuration information of each candidate neighboring cell when L1/L2-based handover is applied based on the transferred configuration information of the reference cell.

In operation 825, each candidate neighboring cell 804 or 805 may include the generated configuration information for L1/L2-based handover in a configuration information response message (L1/L2 config response message) for L1/L2-based handover, and transmit the response message to base station CUI 803.

In operation 830, base station CUI 803 may generate an RRC message and transmit the same to the source cell 802, and the source cell 802 may transfer the RRC message to the terminal 801. The RRC message may include configuration information (Pre-Config1, . . . , Pre-ConfigN) for neighboring candidate cells to which L1/L2-based handover (LTM) is applied. Pre-Config included in the RRC message may include layer 3 (L3) measurement configurations, bearer configurations for the LTM candidate cells, which are generated by the base station, and CellGroupConfig configurations received from the LTM candidate cells in operation 825.

In operation 835, the terminal 801 having received the RRC message performs a procedure of decoding and processing the RRC message. The processing includes ASN.1 decoding and validity determination for the received message, a method of storing and managing configuration details, and the like.

In operation 840, the terminal 801 may perform layer 1 (L1) measurement and reporting for each candidate neighboring cell and may also, at the same time, perform L3 measurement and reporting in operation 845 according to the configurations. In operation 850, base station CUI 803 having received the L3 measurement report may perform a procedure of identifying, from neighboring base station CU2 (gNB2) 806 which may perform handover, whether handover of the terminal 801 is possible. That is, a handover request for the terminal 801 and a response thereto may be received. The response to the handover request may include RRC configuration information applied to a target cell when the handover of the terminal 801 is performed. In addition, in the corresponding operation, base station CU2 (gNB2) 806 may reject the handover request. In operation 840, the source cell 802 having received the L1 measurement report may determine handover based on a corresponding measurement value, and indicate L1/L2 handover to the terminal 801 in operation 855. In this case, a MAC CE and DCI including a handover indicator may be used for L1/L2 signaling. The L1 measurement value transfer for determining L1/L2 handover and the handover determination in operations 840 and 855 may be performed by the source cell (DU) or source base station CU. If base station CU makes all determinations, the source cell may transfer the L1 measurement value received from the terminal, and transfer L1/L2 signaling to the terminal 801 according to the handover determination indication of base station CU. However, when the source cell makes a final determination, the source cell may, without transferring of the L1 measurement value to the base station, determine handover on its own and transfer L1/L2 signaling to the terminal, according to measurement value criteria (threshold and measurement value range) for handover determination for each candidate neighboring cell, which is received from a previous base station. In the embodiment of the disclosure, it is described that the source cell (DU) 802 determines triggering of LTM handover.

In operation 860, when the L1/L2 handover indication is transferred to the terminal 801, the terminal 801 may start a handover procedure and drive a timer for L1/L2 handover. The timer for L1/L2 handover may be a newly configured timer for LTM, or an existing T304 timer may be reused.

In operation 865, the source cell (DU) 802 may transfer, to source base station CU 803, information indicating that LTM has been triggered. This may serve as a request for source base station CU 803 not to trigger an operation (L3 handover indication) related to existing L3 measurement-based handover due to triggering of LTM. The LTM triggering information may be transferred via the F1 interface, and may include an indicator indicating that LTM has been triggered and an index (information capable of indicating a target cell to which LTM has been performed) for LTM cell configuration. Additionally, at the same time, source base station CU 803 may indicate handover in operation 866. In operation 867, the source cell DU may transfer a status of downlink data transmission from the target cell to the base station, and may transmit a message including an indicator for requesting to stop the data transmission. This may be transferred via an existing DL delivery status message or a new message. For reference, when the handover procedure is completed later, the base station having received the message performs a procedure of receiving a status report on downlink data reception from the target cell and transferring the same to the source cell, wherein, when a provided operation is applied, a corresponding procedure may be omitted, resulting in simplification of the procedure. In addition, the role of the message is to transfer a reception state of a downlink data message, and via this, source base station CU1 803 may determine whether to receive downlink data and whether to support additional handover.

In operation 870, source base station CU1 803 may transfer, via an Xn interface, an inter-node message for requesting to stop the ongoing handover procedure to neighboring base station CU2 (gNB2) 806 which may perform layer 3 handover. For this, an existing handover cancel message may be reused, or a new message (e.g., handover stop request message) may be adopted.

In operation 875, in response to the request for the handover stop procedure, neighboring base station CU2 (gNB2) 806 may generate an acceptance or rejection message, and transmit the message to source base station CU1 803. Via these procedures, in response to the handover stop request transferred from source base station CU1 803, base station CU2 (gNB2) 806 releases a handover-related resource for the terminal, thereby further helping base station operation. If base station CU2 (gNB2) 806 accepts to stop the handover procedure, both terminal context and the handover-related procedure of the terminal 801 may be released. When base station CU2 (gNB2) 806 rejects to stop the handover procedure, this may be notified to source base station CU1 803, so that source base station CU1 803 may later re-trigger the handover procedure for the terminal 801. That is, base station CU2 (gNB2) 806 may maintain the context and related configuration for terminal handover until the handover procedure is successful.

In operation 880, the terminal 801 may apply the configuration on the target cell to which L1/L2 handover is applied. The configuration on the target cell to which L1/L2 handover is applied is one of the LTM candidate neighboring cell configurations previously received in operation 830.

In operation 885, according to the applied configuration, the terminal 801 may perform random access when random access is required for the target cell, and when random access is neither indicated nor required (when uplink synchronization is already performed or configured), a random access procedure may be omitted.

In operation 890, the terminal 801 may fail in the LTM handover to the target cell. Reasons for the LTM handover failure may include expiration of a timer for the LTM handover or expiration of an existing T304 timer, a failure of random access to the target cell to which LTM handover is performed, etc.

In operation 893, the terminal 801 may perform the following operations as operations performed when the LTM handover fails. However, the operations are not limited thereto.
When LTM fails, the terminal performs fallback to the previous source cell 802 and attempts to make a connection. To this end, the terminal may need to maintain configuration information for the source cell even when the LTM is triggered. In addition, even after the fallback to the source cell 802, LTM configuration information for the LTM target cell may be maintained. This is to allow LTM to be re-triggered according to the existing configuration.
If the fallback to the source cell cannot be completely performed, the terminal may enter an RRC re-establishment procedure to reselect connectable cells. If a cell found via cell reselection is one of the LTM candidate cells, the terminal may attempt to make a connection by applying a preconfigured RRC configuration for the cell.

In operation 895, the terminal 801 may generate a handover failure report message and transmit the message to base station CU 803, in the connected cell (source cell or target cell). The handover failure report message may be UEInformationResponse or another uplink RRC message. In addition, the handover failure may be reported via a new MAC CE or uplink control signal (uplink control information (UCI)). Information included in the handover failure report message may include the following information. However, the information is not limited thereto.
Indicator indicating that handover has failed due to the LTM failure.
Information of the target cell to which LTM has been attempted and has failed: LTM cell configuration index or actual cell index (physical cell index (PCI)) information.

In operation 897, source base station CU 803 may identify, via the LTM triggering information in operation 865, that source cell DU 802 has triggered LTM, and may identify, via the handover failure message in operation 895, that the LTM attempt has failed and fallback to the source cell has been performed. Accordingly, source base station CU 703 may re-trigger the layer 3 handover procedure that has been pending. This determination may not be performed due to being influenced by determination on layer 3 handover to the target cell according to the information included in the LTM failure message. This is network implementation and, for example, when target cell information associated with the failed LTM and the target cell to which the existing layer 3 handover is performed are the same, the handover may fail again, so that the handover may be re-triggered or canceled via updating to a new configuration value. Additionally, this handover procedure may be the handover procedure that has been pending via operations 870 and 875, and the handover configuration and the target cell may be changed in the middle by a new measurement value and a scheme, such as inter-node message exchange with the base station.

Via this procedure, the base station may avoid triggering duplicate layer 3 handover in a situation where LTM has been triggered, and uncertainty in terminal operation caused by multiple duplicate handover requests may be resolved. If the terminal receives an LTM MAC CE and maintains the connection from the source cell even during the LTM procedure, and uplink/downlink transmission and reception are possible, the existing handover message may be newly triggered even during the LTM handover procedure. In this case, the base station may request a handover in place of LTM when necessary.

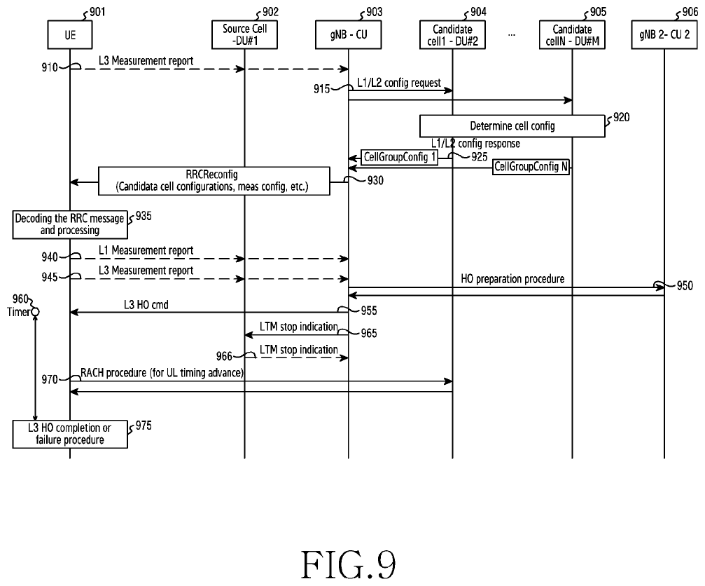

FIG. 9 illustrates overall operations in which existing layer 3 handover is triggered in base station CU and corresponding triggering information is transferred from base station CU to a serving cell (DU), according to various embodiments of the present disclosure. Specifically, FIG. 9 illustrates, as embodiment 2 described in the disclosure, an operation of, when existing layer 3 handover is triggered first, requesting a serving cell not to perform an LTM-related operation.

Referring to FIG. 9, in operation 910, an RRC connected terminal 901 may perform data transmission and reception to and from source cell 1 902 and then transfer, to source cell 1 902, layer 3 measurement values for neighboring cells and a serving cell according to configured layer 3 measurement and reporting. In this case, according to actually configured layer 3 measurement and reporting, the layer 3 measurement values for the neighboring cells and the serving cell may be transmitted to base station CU1 903. This is because base station CU1 903 is responsible for RRC message processing and determines mobility.

In operation 915, base station CU1 903 may generate a message (L1/L2 config request message) for requesting configuration information for L1/L2-based handover and transmit the message via an F1 interface to LTM candidate neighboring cells 904 and 905 according to the measurement value report received from the terminal. In FIG. 9, the candidate cells are illustrated in association with the DUs, but the candidate cells and DUs may be mapped 1:1, or multiple candidate cells may be included in one DU. In addition, the message for requesting configuration information for L1/L2-based handover may be an existing handover request message, a UE context request message, a UE context modification request message, etc., and may be a new F1 or Xn message. The message for requesting configuration information for L1/L2-based handover may be a message for requesting, from neighboring cells, determination as L1/L2-based handover candidate cells and may be, at the same time, a message for requesting RRC configuration information applied when L1/L2-based handover is performed to a corresponding cell. The RRC configuration information (CellGroupConfig 1, . . . , CellGroupConfig N) applied when L1/L2-based handover is performed may be transferred in one of a cell level structure, a cell group level structure, and an RRC message level structure. The message for requesting configuration information for L1/L2-based handover may be for concurrently transferring a configuration and information on a reference cell, and the message for requesting configuration information for L1/L2-based handover may include an indicator for requesting to transfer the configuration information for L1/L2-based handover to the candidate neighboring cells 904 and 905 by applying delta configuration. The indicator for requesting to transfer the configuration information for L1/L2-based handover by applying delta configuration may be requested for each cell or may be commonly requested for all cells.

In operation 920, the candidate neighboring cells 904 and 905 having received the message for requesting configuration information for L1/L2-based handover may generate, based on delta configuration, configuration information of each candidate neighboring cell when L1/L2-based handover is applied based on the transferred configuration information of the reference cell.

In operation 925, each candidate neighboring cell 904 or 905 may include the generated configuration information for L1/L2-based handover in a configuration information response message (L1/L2 config response message) for L1/L2-based handover, and transmit the response message to base station CU1 903.

In operation 930, base station CU1 903 may generate an RRC message and transmit the same to the source cell 902, and the source cell 902 may transfer the RRC message to the terminal 901. The RRC message may include configuration information (Pre-Config1, . . . , Pre-ConfigN) for neighboring candidate cells to which L1/L2-based handover (LTM) is applied. Pre-Config included in the RRC message may include layer 3 (L3) measurement configurations, bearer configurations for the LTM candidate cells, which are generated by the base station, and CellGroupConfig configurations received from the LTM candidate cells in operation 925.

In operation 935, the terminal 901 having received the RRC message performs a procedure of decoding and processing the RRC message. The processing procedure of the terminal may include ASN.1 decoding and validity determination for the received message, a method of storing and managing configuration details, and the like.

In operation 940, the terminal 901 may perform layer 1 (L1) measurement and reporting for each candidate neighboring cell and may also, at the same time, perform L3 measurement and reporting in operation 945 according to the configurations. In operation 950, base station CU1 903 having received the L3 measurement report may perform a procedure of identifying, from neighboring base station CU2 (gNB2) 906 which may perform handover, whether handover of the terminal 901 is possible. That is, a handover request for the terminal 901 and a response thereto may be received. The response to the handover request may include RRC configuration information applied to a target cell when the handover of the terminal is performed. In addition, in this case, base station CU2 (gNB2) 906 may reject the handover request. Accordingly, base station CU 903 may determine whether to indicate layer 3 handover, according to a result of the measurement reporting in operation 945, and may indicate handover in operation 955. When the L3 handover indication is transferred to the terminal 901 via the RRC message, the terminal 901 may start a handover procedure in operation 960 and drive a timer T304 for handover.

In operation 965, base station CU 903 may transmit, to the source cell (DU) 902, a message including an indicator for requesting to stop an LTM-related operation due to triggering of layer 3 handover. For this, source base station CU 903 may request not to trigger an operation (LTM handover indication) related to L1 measurement-based handover associated with LTM due to triggering of handover. The LTM triggering information may be transferred via the F1 interface, and may include an indicator indicating that layer 3 handover has been triggered and an index (information capable of indicating a target cell indicated for handover) for the target cell to which handover has been triggered. Even if the source cell is requested not to trigger a handover-related operation (LTM handover indication), the configurations on the LTM candidate cells may be maintained. This is because, when LTM to another cell is indicated or the handover fails, LTM may be re-triggered.

In operation 966, the source cell (DU) 902 may generate a response message with respect to the indication in operation 965 and transmit the response message to base station CU 903. This response message may include source cell (DU) 902 acceptance/rejection information for the request.

In operation 970, the terminal 901 may apply the configuration on the target cell to which layer 3 handover is applied, and the terminal 901 may perform random access to the target cell according to the applied configuration.

In operation 975, the terminal 901 may fail in the handover to the target cell. Reasons for the failure in the handover to the target cell may include expiration of a timer T304 for handover, a failure of random access to the target cell to which handover is performed, etc. As operations performed when terminal handover fails, the following operations may be performed. However, the operations are not limited thereto.
The terminal generates a handover failure report message in the connected cell (source cell or target cell) and transfers the message to base station CU 903. The handover failure report message may be UEInformationResponse or another uplink RRC message.
When the base station identifies that handover has failed, the base station may transfer information on the handover failure to source cell DU. The information may also include an indicator indicating that layer 3 handover has failed and an index (information capable of indicating a target cell indicated for handover) for the target cell to which handover has been performed.
Source cell DU 902 having received the information may initiate an LTM operation procedure by reapplying previously stored LTM configuration information.

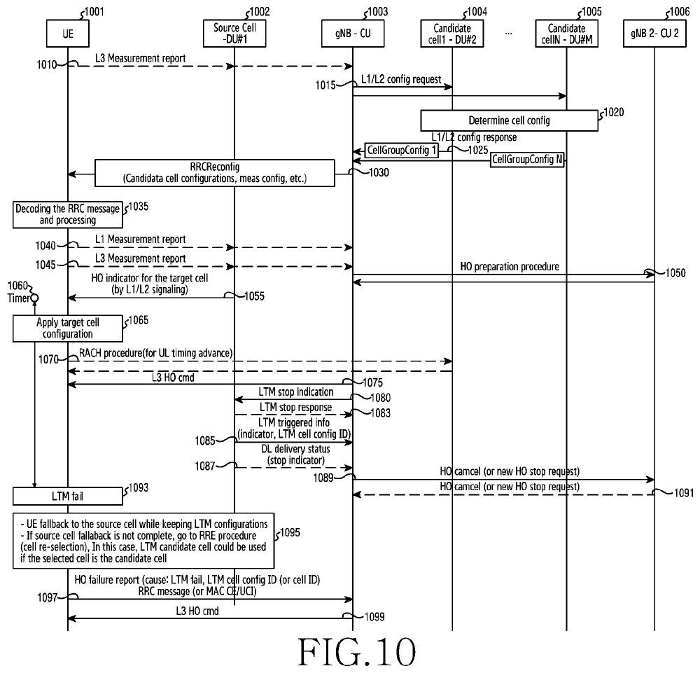

FIG. 10 illustrates overall operations in which base station CU and a serving cell (DU) transfer handover triggering information, according to various embodiments of the present disclosure. Specifically, in comparison with the operations of embodiment 1 and embodiment 2 described in FIG. 8 and FIG. 9, FIG. 10 illustrates, as embodiment 3 described in the disclosure, an operation in which, rather than triggering LTM and immediately transferring information, a serving cell performs reporting only when a request is received from a base station.

In operation 1010, an RRC connected terminal 1001 may perform data transmission and reception to and from source cell 1 1002 and then transfer, to source cell 1 1002, layer 3 measurement values for neighboring cells and a serving cell according to configured layer 3 measurement and reporting. In this case, according to actually configured layer 3 measurement and reporting, the layer 3 measurement values for the neighboring cells and the serving cell may be transmitted to base station CU1 1003. This is because base station CU1 1003 is responsible for RRC message processing and determines mobility.

In operation 1015, base station CU1 1003 may generate a message (L1/L2 config request message) for requesting configuration information for L1/L2-based handover and transmit the message via an F1 interface to LTM candidate neighboring cells 1004 and 1005 according to the measurement value report received from the terminal. In FIG. 10, the candidate cells are illustrated in association with the DUs, but the candidate cells and DUs may be mapped 1:1, or multiple candidate cells may be included in one DU. In addition, the message for requesting configuration information for L1/L2-based handover may be an existing handover request message, a UE context request message, a UE context modification request message, etc., and may be a new F1 or Xn message. The message for requesting configuration information for L1/L2-based handover may be a message for requesting, from neighboring cells, determination as L1/L2-based handover candidate cells and may be, at the same time, a message for requesting RRC configuration information applied when L1/L2-based handover is performed to a corresponding cell. The RRC configuration information (CellGroupConfig 1, . . . , CellGroupConfig N) applied when L1/L2-based handover is performed may be transferred in one of a cell level structure, a cell group level structure, and an RRC message level structure. The message for requesting configuration information for L1/L2-based handover may be for concurrently transferring a configuration and information on a reference cell, and the message may include an indicator for requesting to transfer the configuration information for L1/L2-based handover to the candidate neighboring cells 1004 and 1005 by applying delta configuration. The indicator for requesting to transfer the configuration information for L1/L2-based handover by applying delta configuration may be requested for each cell or may be commonly requested for all cells.

In operation 1020, the candidate neighboring cells 1004 and 1005 having received the message for requesting configuration information for L1/L2-based handover may generate, based on delta configuration, configuration information of each candidate neighboring cell when L1/L2-based handover is applied based on the transferred configuration information of the reference cell.

In operation 1025, each candidate neighboring cell 1004 or 1005 may include the generated configuration information for L1/L2-based handover in a configuration information response message (L1/L2 config response message) for L1/L2-based handover, and transmit the response message to base station CU1 1003.

In operation 1030, base station CU1 1003 may generate an RRC message and transmit the same to the source cell 1002, and the source cell 1002 may transfer the RRC message to the terminal 1001. The RRC message may include configuration information (Pre-Config1, . . . , Pre-ConfigN) for neighboring candidate cells to which L1/L2-based handover (LTM) is applied. Pre-Config included in the RRC message is a message including layer 3 (L3) measurement configurations, bearer configurations for the LTM candidate cells, which are generated by the base station, and CellGroupConfig configurations received from the LTM candidate cells in operation 1025.

In operation 1035, the terminal 1001 having received the RRC message performs a procedure of decoding and processing the RRC message. The processing procedure of the terminal may include ASN.1 decoding and validity determination for the received message, a method of storing and managing configuration details, and the like.

In operation 1040, the terminal 1001 may perform layer 1 (L1) measurement and reporting for each candidate neighboring cell and may also, at the same time, perform L3 measurement and reporting in operation 1045 according to the configurations. In operation 1050, base station CU1 1003 having received the L3 measurement report may perform a procedure of identifying, from neighboring base station CU2 (gNB2) 1006 which may perform handover, whether handover of the terminal 1001 is possible. That is, a handover request for the terminal 1001 and a response thereto may be received. The response to the handover request may include RRC configuration information applied to a target cell when the handover of the terminal 1001 is performed. In addition, in this case, base station CU2 (gNB2) 1006 may reject the handover request. In operation 1040, the source cell 1002 having received the L1 measurement report may determine handover based on a corresponding measurement value, and indicate L1/L2 handover to the terminal in operation 1055. In operation 1050, a MAC CE and DCI including a handover indicator may be used for L1/L2 signaling. The L1 measurement value transfer for determining L1/L2 handover and the handover determination in operations 1040 and 1055 may be performed by the source cell (DU) or source base station CU. If base station CU makes all determinations, the source cell may transfer the L1 measurement value received from the terminal, and transfer L1/L2 signaling to the terminal according to the handover determination indication of base station CU. However, when the source cell makes a final determination, the source cell may, without transferring of the L1 measurement value to the base station, determine handover on its own and transfer L1/L2 signaling to the terminal 1001, according to measurement value criteria (threshold and measurement value range) for handover determination for each candidate neighboring cell, which is received from a previous base station. In the embodiment of the disclosure, it is described that the source cell (DU) determines triggering of LTM handover. When the L1/L2 handover indication is transferred to the terminal, the terminal may start a handover procedure and drive a timer for L1/L2 handover, in operation 1060. The timer may be a newly configured timer for LTM, or an existing T304 timer may be reused.

In operation 1065, the terminal 1001 applies the configuration for the target cell to which L1/L2 handover is applied. The configuration may be one of the LTM candidate neighboring cell configurations previously received in operation 1030.

In operation 1070, according to the applied configuration, the terminal 1001 may perform random access when random access is required for the target cell, and when random access is neither indicated nor required (when uplink synchronization is already performed or configured), a random access procedure may be omitted.

In operation 1075, base station CU 903 may determine whether to indicate layer 3 handover according to a result of the measurement reporting received from the terminal 1001 in operation 1045, and indicate handover to the terminal 1001. This is because the base station determines and triggers handover independently due to having no information on whether source cell DU has triggered LTM. Although the L3 handover indication is transferred to the terminal via the RRC message, the terminal 1001 may not perform a corresponding layer 3 handover operation due to the presence of the ongoing handover procedure.

In operation 1080, base station CU 1003 may transfer, to source cell DU 1002, a message including an indicator for requesting to stop an LTM-related operation due to triggering of layer 3 handover. For this, source base station CU 1003 may request not to trigger an operation (LTM handover indication) related to L1 measurement-based handover associated with LTM due to triggering of handover. The LTM triggering information may be transferred via the F1 interface, and may include an indicator indicating that layer 3 handover has been triggered and an index (information capable of indicating a target cell indicated for handover) for the target cell to which handover has been triggered. Even if the source cell receives this request from the base station, the configurations on the LTM candidate cells may be maintained. This is because, when LTM to another cell is indicated or the handover fails, LTM may be re-triggered.

In addition, in operation 1083, the source cell (DU) 1002 may generate a response message with respect to the indication of base station CU 1003 in operation 1080, and transfer the response message to base station CU 1003. The response message may include source cell (DU) 1002 acceptance/rejection information for the request.

In operation 1085, source cell DU 1002 which has received the indication of base station CU 1003 may report, to base station CU 1003, that LTM has already been triggered in operation 1085. This may serve to inform source base station CU 1003 that LTM has already been triggered and that the layer 3 handover triggered by the base station may not be performed. In addition, this may also serve as a request to avoid triggering an operation (L3 handover indication) related to the existing L3 measurement-based handover. The LTM triggering information may be transferred via the F1 interface, and may include an indicator indicating that LTM has been triggered and an index (information capable of indicating a target cell to which LTM has been performed) for LTM cell configuration.

In operation 1087, source cell DU 1002 may transfer a status of downlink data transmission from the target cell to base station CU 1003, and may transmit a message including an indicator for requesting to stop the data transmission. The message including the indicator for requesting to stop the data transmission may be transferred via an existing DL delivery status message or a new message. For reference, when the handover procedure is completed later, the base station having received the message may perform a procedure of receiving a status report on downlink data reception from the target cell and transferring the same to the source cell, wherein, when a provided operation is applied, a corresponding procedure may be omitted, resulting in simplification of the procedure. In addition, the role of the message is to transfer a reception state of a downlink data message, and via this, source base station CU1 1003 may determine whether to receive downlink data and whether to support additional handover.

In operation 1089, source base station CU1 1003 may transfer, via the Xn interface, an inter-node message for requesting to stop the ongoing handover procedure to neighboring base station CU2 (gNB2) 1006 which may perform layer 3 handover.

In operation 1091, neighboring base station CU2 (gNB2) 1006 may generate and transmit an acceptance or rejection message to source base station CU1 1003 in response to the request to stop the handover procedure, which is received from source base station CU1 1003. In response to the handover stop request transferred from source base station CU1 1003, base station CU2 (gNB2) 1006 may release a handover-related resource for the terminal, thereby efficiently operating the base station. If base station CU2 (gNB2) 1006 accepts to stop the handover procedure, both terminal context and the handover-related procedure of the terminal may be released. When base station CU2 (gNB2) 1006 rejects to stop the handover procedure, this may be notified to source base station CU1 1003, so that source base station CU1 1003 may later re-trigger the handover procedure for the terminal. That is, base station CU2 (gNB2) 1006 may maintain the context and related configuration for terminal handover until the handover procedure is successful.

In operation 1093, the terminal 1001 may fail in the LTM handover to the target cell. Reasons for the LTM handover failure may include expiration of a timer for the LTM handover or expiration of an existing T304 timer, a failure of random access to the target cell to which LTM handover is performed, etc. As operations performed when the terminal 1001 fails in the LTM handover, the following operations may be performed in operation 1095. However, the operations are not limited thereto.
When LTM fails, the terminal performs fallback to the previous source cell 1002 and attempts to make a connection. To this end, the terminal may need to maintain configuration information for the source cell even when the LTM is triggered. In addition, even after the fallback to the source cell 1002, LTM configuration information for the LTM target cell is maintained. This is to allow LTM to be re-triggered according to the existing configuration.
If the fallback to the source cell cannot be completely performed, the terminal enters an RRC re-establishment procedure to reselect connectable cells. If a cell found via cell reselection is one of the LTM candidate cells, the terminal may attempt to make a connection by applying a preconfigured RRC configuration for the cell.

Then, in operation 1097, the terminal 1001 may generate a handover failure report message and transfer the message to base station CU 1003, in the connected cell (source cell or target cell). The handover failure report message may be UEInformationResponse or another uplink RRC message. In addition, the handover failure may be reported via a new MAC CE or uplink control signal (uplink control information (UCI)). Information included in the handover failure report message may include the following information.
Indicator indicating that handover has failed due to the LTM failure.
Information of the target cell to which LTM has been attempted and has failed: LTM cell configuration index or actual cell index (physical cell index (PCI)) information.

In operation 1099, source base station CU 1003 may identify, via the LTM triggering information in operation 1055, that source cell DU 1002 has triggered LTM, and may identify, via the handover failure message in operation 1097, that the LTM attempt has failed and fallback to the source cell has been performed. Accordingly, source base station CU 1003 may re-trigger the layer 3 handover procedure that has been pending. The determination may not be performed due to being influenced by determination on layer 3 handover to the target cell according to the information included in the LTM failure message. This is network implementation and, for example, if target cell information associated with the failed LTM and the target cell to which the existing layer 3 handover is performed are the same, the handover may fail again, so that the handover may be re-triggered or canceled via updating to a new configuration value. For reference, this handover procedure may be the handover procedure that has been pending via operations 1093 and 1095, and the handover configuration and the target cell may be changed in the middle by a new measurement value and a scheme, such as inter-node message exchange with the base station.

Via the embodiment, the base station may once again manage duplicate layer 3 handover in a situation where LTM has been triggered, and uncertainty in the terminal and base station operations caused by multiple duplicate handover requests may be resolved. When the terminal receives an LTM MAC CE and maintains the connection from the source cell even during the LTM procedure, and uplink/downlink transmission and reception are possible, the existing handover message may allow triggered layer 3 operations during the LTM handover procedure. In this case, the base station may request a handover in place of LTM when necessary.

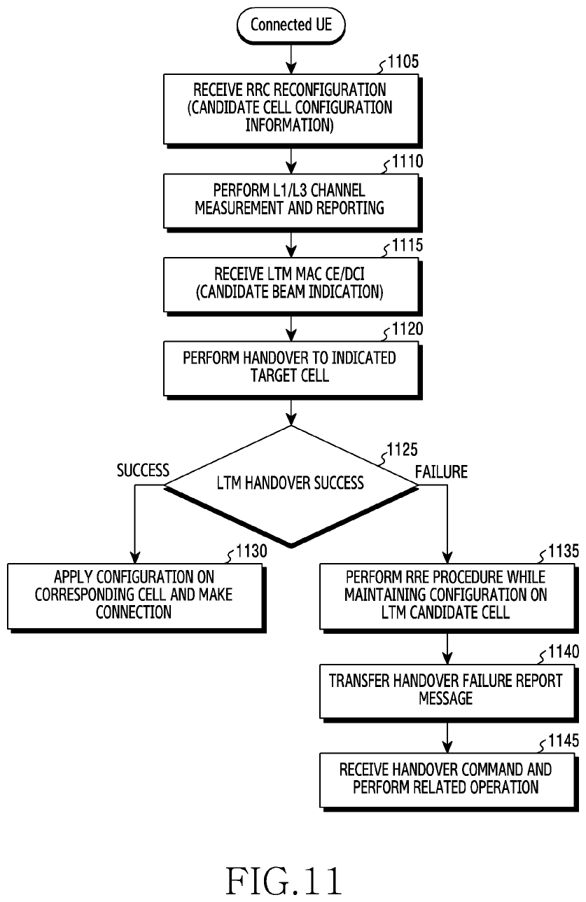

FIG. 11 illustrates operations of performing L1/L2-based beam change and terminal handover, according to various embodiments of the present disclosure. In particular, a terminal operation of the disclosure includes an operation for solving a case where LTM and layer 3 handover are redundantly indicated.

In operation 1105, a connected terminal may receive, via an RRC reconfiguration message from a serving cell, configuration information in neighboring cells, which is applied after L1/L2-based moving is indicated. For detailed configuration methods and details, reference is made to the descriptions of FIG. 6 to FIG. 10. In addition, although omitted, before RRC configuration information, the terminal has received a basic RRC configuration from a base station, and the terminal may report layer 3 measurement values for neighboring cells. In particular, the configuration information in neighboring cells, which is received in operation 1105, may be transferred by applying of delta configuration based on a configuration of one reference cell, the configuration information being applied after L1/L2-based moving is indicated. The terminal may identify a reference cell and configuration information for the reference cell, which are previously informed or indicated in the RRC configuration, and configurations on neighboring cells other than the reference cell may result in less signaling overhead due to configuring and transferring of only a part differing from the reference cell. The terminal may decode the received configurations on the neighboring cells, based on the configuration of the reference cell in the corresponding operation, and store and manage the actually applied configuration (i.e., an operation of storing the configuration, to which delta configuration is applied based on the reference cell, as full configuration by referring to the reference cell configuration) in a separate buffer and list. Alternatively, the terminal may store and manage the received RRC configurations as it is in a buffer, without decoding the received configurations, based on the reference cell, and storing and managing the actually applied configuration. In the corresponding operation, when the configurations on the neighboring cells are decoded based on the reference cell, and the actually applied configuration is stored, thereby indicating actual L1/L2-based handover, handover to a corresponding cell may be applied immediately, resulting in no additional delay time.

In operation 1110, the terminal may perform L1 measurement associated with candidate neighboring cells while maintaining the connection with the serving cell, and may report corresponding measurement results according to a preconfigured L1 measurement reporting configuration method. In addition, independently of the operation, the terminal may measure the neighboring cells according to an L3 measurement configuration, and report corresponding measurement results to the base station according to an L3 measurement reporting configuration. The serving cell may determine, based on the received measurement results, whether to perform beam change and handover of the terminal, and when a change to a specific beam of the neighboring cells is determined to be necessary rather than a specific beam of the serving cell, the handover and beam change of the terminal may be indicated via L1/L2 signaling in operation 1115. FIG. 11 illustrates a case where the L1/L2 signaling is a MAC CE and DCI, wherein information indicating the change of the serving cell and the specific cell of the neighboring cells may all be indicated (when the MAC CE indicates only one beam) in the MAC CE, and then in the transferred DCI, handover may be indicated by selecting one of multiple beams of the neighboring cells activated in the MAC CE.

In operation 1120, the terminal may check whether handover is indicated from the MAC CE and DCI signaling received in operation 1115, and perform an LTM handover operation. When the received MAC CE and DCI indicate handover (when the MAC CE itself indicates handover, or the MAC CE activates multiple beams, and the DCI indicates handover while indicating one of the beams), the terminal may perform handover to a cell associated with an indicated TCI state.

When random access is successfully performed, and thus handover is successful in operation 1125, the terminal in operation 1130 may also apply a configuration on a corresponding target cell, which has been stored as the received pre-configuration on the neighboring cell, and connect to the cell, thereby performing data transmission and reception using the indicated beam.

If the terminal fails in LTM handover in operation 1125, the terminal may fallback to the previous source cell and attempt to make a connection, in operation 1135. In order to fallback to the previous source cell and attempt to make the connection, the terminal may need to maintain the configuration information for the source cell even when LTM is triggered. In addition, even after the fallback to the source cell, LTM configuration information for the LTM target cell may be maintained. This is to allow LTM to be re-triggered according to the existing configuration. If the fallback to the source cell cannot be completely performed, the terminal may enter an RRC re-establishment procedure to reselect connectable cells. If a cell found via cell reselection is one of the LTM candidate cells, the terminal may attempt to make a connection by applying a preconfigured RRC configuration for the cell.

Then, in operation 1140, the terminal may generate a handover failure report message and transfer the message to base station, in the connected cell (source cell or target cell). The handover failure report message may be UEInformationResponse or another uplink RRC message. In addition, the handover failure may be reported via a new MAC CE or uplink control signal (uplink control information (UCI)). Information included in the handover failure report message may include the following information. However, the information is not limited thereto.
Indicator indicating that handover has failed due to the LTM failure.
Information of the target cell to which LTM has been attempted and has failed: LTM cell configuration index or actual cell index (physical cell index (PCI)) information.

Then, in operation 1140, the source base station may identify, via the handover failure message reporting, that the LTM attempt has failed and fallback to the corresponding cell has been performed. Accordingly, the source base station may re-trigger the layer 3 handover procedure that has been pending. Determination of re-triggering the handover procedure by the source base station may not be performed due to being influenced by determination on layer 3 handover to the target cell according to the information included in the LTM failure message. This is network implementation and, for example, if target cell information associated with the failed LTM and the target cell to which the existing layer 3 handover is performed are the same, the handover may fail again, so that the handover may be re-triggered or canceled via updating to a new configuration value.

Although omitted in this drawing, if the terminal is able to receive an RRC message from the source cell even while performing LTM handover to the target cell (if equipped with corresponding capability) in operation 1120, the terminal may perform a handover operation in response to the received layer 3 handover request. The operation may be performed by one of the following methods.
Performing a high priority handover operation (LTM or layer 3 handover: priority is specified in the standard or provided via signaling);
Continuously performing a currently running handover procedure; and/or
Performing a newly indicated handover procedure (stopping the existing handover procedure).

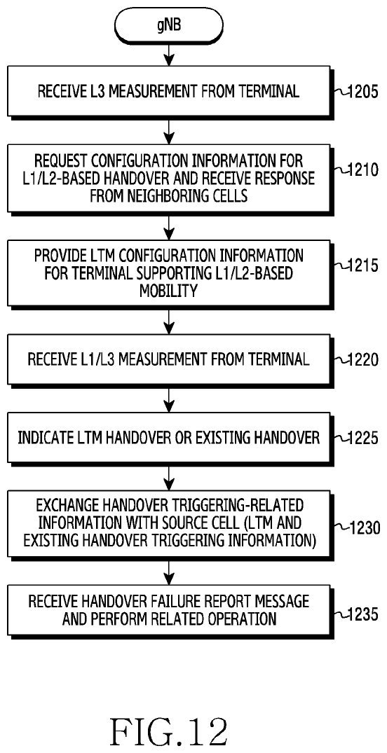

FIG. 12 illustrates a base station operation according to various embodiments of the present disclosure.

In operation 1205, a base station may receive an L3 measurement value report from a terminal, and may identify whether the terminal requires handover and which cells are handover candidate cells, based on measurement values of the terminal with respect to neighboring frequencies and cells.

In operation 1210, the base station may request configuration information for L1/L2-based handover from the neighboring cells and receive responses from the cells. In the operation, the base station receives, based on delta configuration, RRC configuration information from the neighboring cells, and the base station may inform the neighboring cells of a reference cell and a reference cell configuration, and receive configuration information for L1/L2-based handover for other neighboring cells, based on the reference cell configuration. Although omitted in this drawing, before the operation, a configuration related to an L3 measurement configuration and a basic RRC configuration are provided.

In operation 1215, the base station may transmit, to the connected terminal, an RRC configuration message generated including the neighboring cell configuration information received in operation 1210. That is, configuration information in the neighboring cells, which is applied after L1/L2-based moving is indicated, may be transmitted from a serving cell via an RRC reconfiguration message. Specific descriptions are provided with reference to FIG. 6 to FIG. 10.

Then, in operation 1220, the base station may receive reports on L1 and L3 measurement values from the terminal, in which case, the L1 measurement value may be for a neighboring cell (non-serving cell) that supports L1/L2-based mobility. The serving cell may determine, based on the received measurement results, whether to perform beam change and handover of the terminal, and when a change to a specific beam of the neighboring cells is determined to be necessary rather than a specific beam of the serving cell, the base station may indicate, in operation 1225, LTM handover of the terminal via L1/L2 signaling. The L1/L2 signaling may be a MAC CE or DCI, and may include information indicating a change to a specific beam of the neighboring cells. In addition, in the operation, the existing handover via the RRC message may also be independently performed and indicated. This may occur because the base station and serving cell independently determine LTM and layer 3 handover.

In operation 1230, in order to solve such a problem, base station CU and serving cell DU may transfer handover information triggered by a corresponding entity to another node so as to prevent duplicate handover indications. That is, when handover is triggered, source base station CU may transmit existing handover triggering information to source cell DU. When LTM is triggered, source cell DU may transmit LTM triggering information to source base station CU. As handover-related information, an indicator indicating that layer 3 handover or LTM has been triggered and an index (information capable of indicating a target cell indicated for handover) for the target cell to which handover has been triggered may be included. For detailed operations, reference may be made to FIG. 8, FIG. 9, and FIG. 10 illustrating embodiments 1, 2, and 3.

Then, in operation 1235, the base station may receive, from the terminal, a handover failure report message including information on the handover failure. This may be a message indicating that the terminal has attempted to connect to the corresponding cell again after the handover failure. The handover failure report message may be UEInformationResponse or another uplink RRC message. In addition, the handover failure may be reported via a new MAC CE or uplink control signal (uplink control information (UCI)). Information included in the handover failure report message may include the following information. However, the information is not limited thereto.
Indicator indicating that handover has failed due to the LTM failure.
Information of the target cell to which LTM has been attempted and has failed: LTM cell configuration index or actual cell index (physical cell index (PCI)) information.

The source base station may identify, via the handover failure message reporting, that the LTM attempt has failed and fallback to the corresponding cell has been performed. Accordingly, the source base station may re-trigger the layer 3 handover procedure that has been pending. Determination of re-triggering the handover procedure may not be performed due to being influenced by determination on layer 3 handover to the target cell according to the information included in the LTM failure message. This is network implementation and, for example, if target cell information associated with the failed LTM and the target cell to which the existing layer 3 handover is performed are the same, the handover may fail again, so that the handover may be re-triggered or canceled via updating to a new configuration value.

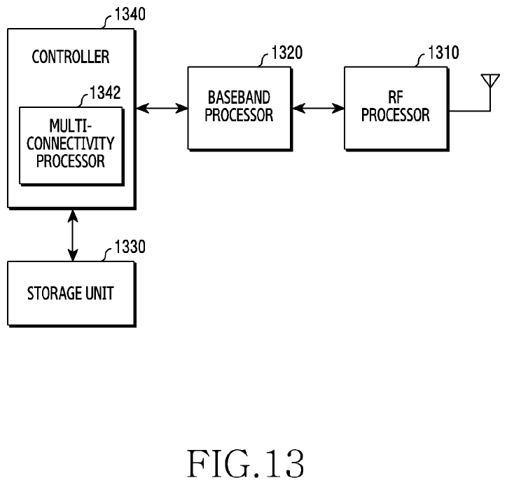

FIG. 13 illustrates a structure of a terminal according to various embodiments of the present disclosure.

Referring to FIG. 13, the terminal includes a radio frequency (RF) processor 1310, a baseband processor 1320, a storage unit 1330, and a controller 1340.

The RF processor 1310 may perform a function for signal transmission and reception via a wireless channel, such as signal band transform and amplification. That is, the RF processor 1310 may up-convert a baseband signal provided from the baseband processor 1320 into an RF band signal, transmit the converted RF band signal via an antenna, and then down-convert the RF band signal received via the antenna into a baseband signal. For example, the RF processor 1310 may include a transmission filter, a reception filter, an amplifier, a mixer, an oscillator, a digital-to-analog converter (DAC), an analog-to-digital converter (ADC), and the like. In FIG. 13, only one antenna is illustrated, but the terminal may have multiple antennas. The RF processor 1310 may include multiple RF chains. Furthermore, the RF processor 1310 may perform beamforming. In order to perform beamforming, the RF processor 1310 may adjust a phase and a magnitude of each of signals transmitted and received via multiple antennas or antenna elements. The RF processor 1310 may perform MIMO, and may receive multiple layers when performing a MIMO operation.

The baseband processor 1320 may perform a function of conversion between a baseband signal and a bitstream according to a physical layer specification of the system. For example, during data transmission, the baseband processor 1320 may generate complex symbols by encoding and modulating a transmission bitstream. In addition, during data reception, the baseband processor 1320 may reconstruct a reception bitstream via demodulation and decoding of a baseband signal provided from the RF processor 1310. For example, when conforming to an orthogonal frequency division multiplexing (OFDM) scheme, during data transmission, the baseband processor 1320 may generate complex symbols by encoding and modulating a transmission bitstream, map the complex symbols to sub-carriers, and then configure OFDM symbols via an inverse fast Fourier transform (IFFT) operation and cyclic prefix (CP) insertion. In addition, during data reception, the baseband processor 1320 may divide the baseband signal provided from the RF processor 1310 in units of OFDM symbols, reconstruct the signals mapped to the sub-carriers via a fast Fourier transform (FFT) operation, and then reconstruct the reception bitstream via demodulation and decoding.

The baseband processor 1320 and the RF processor 1310 may transmit and receive signals as described above. Accordingly, the baseband processor 1320 and the RF processor 1310 may be referred to as a transmitter, a receiver, a transceiver, or a communication unit. Furthermore, at least one of the baseband processor 1320 and the RF processor 1310 may include multiple communication modules to support multiple different radio access technologies. In addition, at least one of the baseband processor 1320 and the RF processor 1310 may include different communication modules to process signals of different frequency bands. For example, the different radio access technologies may include a wireless LAN (e.g., IEEE 802.11), a cellular network (e.g., LTE), and the like. In addition, the different frequency bands may include a super high frequency (SHF) (e.g., 2.NRHz, NRhz) band, and a millimeter wave (e.g., 60 GHz) band.

The storage unit 1330 may store data, such as a basic program, an application program, configuration information, and the like for operation of the terminal. Particularly, the storage unit 1330 may store information on a second access node that performs wireless communication using a second radio access technology. In addition, the storage unit 1330 may provide stored data in response to a request of the controller 1340.

The controller 1340 may control overall operations of the terminal. For example, the controller 1340 may transmit and receive signals via the baseband processor 1320 and the RF processor 1310. In addition, the controller 1340 may record and read data in the storage unit 1340. To this end, the controller 1340 may include at least one processor. For example, the controller 1340 may include a communication processor (CP) configured to perform control for communication, and an application processor (AP) configured to control a higher layer, such as an application program.

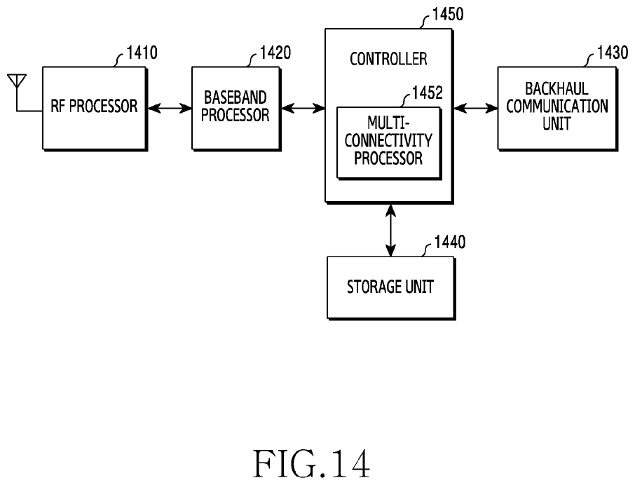

FIG. 14 illustrates a structure of a base station according to various embodiments of the present disclosure.

Referring to FIG. 14, the base station includes an RF processor 1410, a baseband processor 1420, a backhaul communication unit 1430, a storage unit 1440, and a controller 1450.

The RF processor 1410 may perform a function for signal transmission and reception via a wireless channel, such as signal band transform and amplification. That is, the RF processor 1410 may up-convert a baseband signal provided from the baseband processor 1420 into an RF band signal, transmit the converted RF band signal via an antenna, and then down-convert the RF band signal received via the antenna into a baseband signal. For example, the RF processor 1410 may include a transmission filter, a reception filter, an amplifier, a mixer, an oscillator, a DAC, an ADC, and the like. In FIG. 14, only one antenna is illustrated, but a first access node may include multiple antennas. The RF processor 1410 may include multiple RF chains. Furthermore, the RF processor 1410 may perform beamforming. In order to perform beamforming, the RF processor 1410 may adjust a phase and a magnitude of each of signals transmitted and received via multiple antennas or antenna elements. The RF processor 1410 may perform a downlink MIMO operation by transmitting one or more layers.

The baseband processor 1420 performs a function of conversion between a baseband signal and a bitstream according to a physical layer specification of a first radio access technology. For example, during data transmission, the baseband processor 1420 may generate complex symbols by encoding and modulating a transmission bitstream. In addition, during data reception, the baseband processor 1420 may reconstruct a reception bitstream via demodulation and decoding of a baseband signal provided from the RF processor 1410. For example, when conforming to an OFDM scheme, during data transmission, the baseband processor 1420 may generate complex symbols by encoding and modulating a transmission bitstream, map the complex symbols to sub-carriers, and then configure OFDM symbols via an IFFT operation and CP insertion. In addition, during data reception, the baseband processor 1420 may divide the baseband signal provided from the RF processor 1410 in units of OFDM symbols, reconstruct the signals mapped to the sub-carriers via an FFT operation, and then reconstruct the reception bitstream via demodulation and decoding. The baseband processor 1420 and the RF processor 1410 may transmit and receive signals as described above. Accordingly, the baseband processor 1420 and the RF processor 1410 may be referred to as a transmitter, a receiver, a transceiver, a communication unit, or a wireless communication unit.

The backhaul communication unit 1430 may provide an interface to perform communication with other nodes within a network. That is, the backhaul communication unit 1430 may convert, into a physical signal, a bitstream transmitted from a main base station to another node, for example, an auxiliary base station and a core network, and may convert a physical signal received from another node into a bitstream.

The storage unit 1440 may store data, such as a basic program, an application program, configuration information, and the like for operation of the base station. In particular, the storage unit 1440 may store information on a bearer assigned to a connected terminal, a measurement result reported from the connected terminal, and the like. In addition, the storage unit 1440 may store information serving as a criterion for determining whether to provide a terminal with multi-connectivity or to suspend multi-connectivity. The storage unit 1440 may provide stored data in response to a request of the controller 1450.

The controller 1450 may control overall operations of the main base station. For example, the controller 1450 may transmit and receive signals via the baseband processor 1420 and the RF processor 1410. In addition, the controller 1450 may record and read data in the storage unit 1440. To this end, the controller 1450 may include at least one processor.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a distributed unit (DU) of a base station in a wireless communication system, the method comprising:
identifying that a layer triggered mobility (LTM) is triggered based on a measurement report received from a user equipment (UE); and
transmitting, to a central unit (CU) of the base station, a first message for notifying that the LTM is triggered.

2. The method of claim 1, wherein the first message includes an indicator associated with a cell switch based on the LTM.

3. The method of claim 1, further comprising:
receiving, from the CU of the base station, a second message for notifying that a layer 3 (L3) handover is triggered, wherein the second message is received within a predetermined time period based on a transmission of the first message; and
identifying that the LTM has a higher priority than the L3 handover.

4. The method of claim 3, wherein the second message includes an indicator for indicating to stop data transmission to the UE.

5. The method of claim 1, wherein, in case that a third message for notifying that an L3 handover is triggered is received before the LTM is triggered, the L3 handover has a higher priority than the LTM.

6. A method performed by a central unit (CU) of a base station in a wireless communication system, the method comprising:
receiving, from a distributed unit (DU) of the base station, a first message for notifying that a layer triggered mobility (LTM) is triggered,
wherein the LTM is identified by the DU of the base station based on a measurement report received from a user equipment (UE).

7. The method of claim 6, wherein the first message includes an indicator associated with a cell switch based on the LTM.

8. The method of claim 6, further comprising:
transmitting, to the DU of the base station, a second message for notifying that a layer 3 (L3) handover is triggered, wherein the second message is received within a predetermined time period based on a reception of the first message,
wherein the LTM is identified by the DU of the base station as having a higher priority than the L3 handover, and
wherein the second message includes an indicator for indicating to stop data transmission to the UE.

9. The method of claim 6, wherein, in case that a third message for notifying that an L3 handover is triggered is received before the LTM is triggered, the L3 handover has a higher priority than the LTM.

10. A distributed unit (DU) of a base station in a wireless communication system, the DU of the base station comprising:
a transceiver; and
a controller coupled with the transceiver and configured to:
identify that a layer triggered mobility (LTM) is triggered based on a measurement report received from a user equipment (UE), and
transmit, to a central unit (CU) of the base station, a first message for notifying that the LTM is triggered.

11. The DU of claim 10, wherein the first message includes an indicator associated with a cell switch based on the LTM.

12. The DU of claim 10, wherein the controller is further configured to:
receive, from the CU of the base station, a second message for notifying that a layer 3 (L3) handover is triggered, wherein the second message is received within a predetermined time period based on a transmission of the first message; and
identify that the LTM has a higher priority than the L3 handover.

13. The DU of claim 12, wherein the second message includes an indicator for indicating to stop data transmission to the UE.

14. The DU of claim 10, wherein, in case that a third message for notifying that an L3 handover is triggered is received before the LTM is triggered, the L3 handover has a higher priority than the LTM.

15. A central unit (CU) of a base station in a wireless communication system, the CU of the base station comprising:
a transceiver; and
a controller coupled with the transceiver and configured to:
receive, from a distributed unit (DU) of the base station, a first message for notifying that a layer triggered mobility (LTM) is triggered,
wherein the LTM is identified by the DU of the base station based on a measurement report received from a user equipment (UE).

16. The CU of claim 15, wherein the first message includes an indicator associated with a cell switch based on the LTM.

17. The CU of claim 15, wherein the controller is further configured to:
transmit, to the DU of the base station, a second message including second message for notifying that a layer 3 (L3) handover is triggered, wherein the second message is received within a predetermined time period based on a reception of the first message,
wherein the LTM is identified by the DU of the base station as having a higher priority than the L3 handover, and
wherein the second message includes an indicator for indicating to stop data transmission to the UE.

18. The CU of claim 15, wherein, in case that a third message for notifying that an L3 handover is triggered is received before the LTM is triggered, the L3 handover has a higher priority than the LTM.

19. A method performed by a user equipment (UE) in a wireless communication system, the method comprising:
transmitting, to a distributed unit (DU) of a base station, a measurement report; and
receiving, from the DU of the base station, switching command message based on a layer triggered mobility (LTM),
wherein the LTM is triggered based on the measurement report, and
wherein, in case that the LTM is triggered before a trigger of a layer 3 (L3) handover, the LTM has a higher priority than the L3 handover.

20. A user equipment (UE) in a wireless communication system, the UE comprising:
a transceiver; and
a controller coupled with the transceiver and configured to:
transmit, to a distributed unit (DU) of a base station, a measurement report, and
receive, from the DU of the base station, switching command message based on a layer triggered mobility (LTM),
wherein the LTM is triggered based on the measurement report,
wherein, in case that the LTM is triggered before a trigger of a layer 3 (L3) handover, the LTM has a higher priority than the L3 handover.
